(19) United States
(12) Patent Application Publication
(10) Pub. No.: US 2023/0173493 A1
(43) Pub. Date: Jun. 8, 2023

(54) ASSAY PLATE WITH NANO-VESSELS AND SAMPLE RECOVERY ASSEMBLY

(71) Applicant: Scienion GmbH, Berlin (DE)

(72) Inventor: Joshua CANTLON-BRUCE, Spokane, WA (US)

(21) Appl. No.: 17/923,815

(22) PCT Filed: May 6, 2021
(86) PCT No.: PCT/EP2021/062032

§ 371 Date: Nov. 7, 2022

Related U.S. Application Data
(60) Provisional application No. 63/021,851, filed on May 8, 2020.

(51) Int. Cl. B01L 3/00; B01L 9/00

(52) U.S. Cl. CPC B01L 3/50853; B01L 9/523; B01L 2300/0896; B01L 2200/027; B01L 2200/16; B01L 2300/0829; B01L 2400/0409

(57) ABSTRACT

An assay plate is provided. The assay plate has a body with a plurality of reservoirs formed therein. The reservoirs are shaped and aligned in the body in an orientation to induce drainage of fluids contained therein in a desired direction. A plate array and a funnel array forming an assembly for pooling of samples contained in the assay plate is also provided.

### FIELD OF THE INVENTION

The present invention is in the field of biochemical analysis and provides assay plates, plate arrays and assemblies including recovery funnels for recovery of samples from reservoirs on the assay plates.

### BACKGROUND

Single-cell studies have become more prominent in recent years in fields such as stem cell biology, hematology, cancer biology and tissue engineering. Measuring cells in populations involves analysis of average signals from a large number of cells. It is highly challenging to analyze cell types constituting a minority in such samples because their properties are hidden by the majority population. Thus, an appropriate analysis of samples with significant cellular heterogeneity is ideally performed on a single-cell level. Many applications in drug discovery or medical diagnostics, such as single-cell microarrays, single-cell PCR, isolation of rare cells, or production of clonal cell lines, could benefit significantly from analytical approaches based on single cells.

In practice, separation and manipulation of individual living biological cells remains a challenging task in many life science applications. At present, the commercially available technologies to separate single cells from a suspension and deposit them individually on substrates are quite rare, especially regarding processing of nontreated samples and label-free cells (Gross et al. J. Lab. Automation 2013, 18(6), 504-518, incorporated herein by reference in its entirety).

Technologies for single-cell isolation, e. g. for handling of single cells in biotechnology and medicine, include flow cytometry, manual cell picking, microfluidic techniques, and inkjet-like single-cell printing. In general terms, a single-cell printer isolates a single cell and places it in a receptacle having a micro- or nano-scale volume wherein a subsequent assay is conducted. A single-cell printer typically comprises a microfluidic dispenser integrated in a polymer cartridge. Droplets of a cell suspension included in the dispenser are deposited in a receptacle on a target substrate. Single-cell printing has advantages in terms of flexibility and easy interfacing with other upstream and downstream methods. However, single-cell printers have to be controlled such that each droplet deposited onto the target includes one single cell only (Gross et al. Int. J. Mol Sci. 2015, 16, 16897-16919, incorporated herein by reference in its entirety).

Examples of single cell printing are described and claimed in commonly owned European Patent Application Publication No. EP3222353 and European Patent Application No. EP17189875, each of which are incorporated herein by reference in entirety.

There continues to be a need for development of technologies for single cell isolation and manipulation.

### SUMMARY

One aspect of the invention is an assay plate which includes a body having a plurality of reservoirs formed therein. The reservoirs are shaped and aligned in the body in an orientation to induce drainage of fluids contained therein in a desired direction. The desired direction may be towards a single plane or a single point.

In some embodiments, the reservoirs each have a spout portion which has a vertex directed toward the single plane or the single point.

The reservoirs may be provided with a downwardly tapered frustoconical portion adjacent to the spout portion. The frustoconical portion may have a frustrum forming the base of the reservoir.

The reservoirs may have a boundary between the frustoconical portion and the spout portion defined by a pair of opposed transition planes each intersecting an inner sidewall of the reservoir at distances equidistant from the vertex such that a connectivity plane located between the vertex and the center of the base divides the spout into symmetric halves. In such embodiments, a first angle between a first perpendicular reference plane intersecting the edge of the base closest to the vertex and the connectivity plane is greater than a second angle between a second perpendicular reference plane intersecting the edge of the base in the frustoconical portion and an interior sidewall of the frustoconical portion.

The reservoir may have a teardrop-shaped upper edge and the base may be circular or teardrop shaped.

In some embodiments, the spout includes a ledge portion, wherein a third angle between the first perpendicular reference plane and the connectivity plane on the ledge portion is greater than the first angle between the first perpendicular reference plane intersecting the edge of the base closest to the vertex and the connectivity plane.

In some embodiments, the body of the plate array may be rectangular and provided with a downward slope from a single elevated corner, wherein the desired direction of the drainage of fluids is towards the corner opposite the elevated corner. In other embodiments, the body may be rectangular with a level upper surface.

In some embodiments, the plurality of reservoirs is 96 reservoirs.

In some embodiments, the reservoirs have volumes of less than about 500 nanoliters.

Another aspect of the invention is a plate array comprising a plurality of assay plates of the embodiments described hereinabove. In one embodiment, the plurality of assay plates is four plates.

Another aspect of the invention is assembly for pooling assay samples contained in reservoirs of plate arrays. The assembly may include a rectangular plate array as described hereinabove and a rectangular funnel array comprising a plurality of rectangular funnels, each configured for connection to a single plate of the plurality of plates.

Each of the rectangular funnels of the funnel array may have a collecting vessel located closer to one funnel corner such that when the funnel array is connected to the plate array, the desired direction of drainage of fluids from each plate of the plurality of rectangular plates is towards the collecting vessel of the connected funnel.

The corners of the plate array may be shaped to accept the corners of the funnel array in only a single orientation, thereby ensuring that the desired direction of drainage of fluids is towards the collecting vessel.

A transverse channel may be provided between adjacent plates of the plate array.

The assembly may also include a housing for coupling the assembly to a rotor of a centrifuge.

Another aspect of the invention is a kit for conducting an assay. The kit includes a plate array as described hereinabove, a rectangular funnel array comprising a plurality of rectangular funnels, each configured for connection to a single plate of the plurality of plates, and instructions for connecting the funnel array to the plate array for draining fluids from the reservoirs of the plate array via centrifugation.

The kit may also include a housing for retaining the plate array and funnel array in a connected arrangement in a centrifuge.

In some embodiments of the kit, the collecting vessels are attached to or formed integrally with the funnels of the funnel array.

The kit may also include a frame configured to hold the plate array during dispensing of components into the reservoirs during preparation of the assay.

In some embodiments of the kit, each one of the reservoirs includes an identifier for identifying each one of the reservoirs during the assay. The identifier may be a fluorescent, chemiluminescent, or colorimetric molecule, nucleic acid molecule, protein, glycan, peptide, aptamer, small molecule, nanoparticle, or a heavy metal with an isotope which is identifiable by mass spectrometry. Other analytical techniques may be used to confirm the presence of the identifier.

The kit may also include reagents for the assay provided in individual vessels.

In some embodiments of the kit, the assay is a sequencing assay, a gene expression assay or a protein expression assay.

Another aspect of the invention is an assay plate comprising a body having a plurality of reservoirs formed therein. The reservoirs are shaped and aligned in the body in an orientation to induce drainage of fluids contained therein, in a desired direction. The reservoirs have a plurality of shelves.

The plate may induce direction toward a single plane of a single point.

The reservoirs each have a spout portion having a vertex directed toward the single plane or the single point.

The plurality of shelves is located about a central axis of the reservoir.

The plurality of shelves comprises three shelves. A first shelf is located opposite the spout and the other two shelves are located opposite one another, each spaced between the first shelf and the spout.

Each of the plurality of shelves is located between a bottom of the reservoir and an upper edge of the reservoir.

At least one of the plurality of shelves is generally parallel to a bottom of the reservoir.

At least one of the plurality of shelves intersects with a sidewall of the reservoir at an angle.

At least one of the plurality of shelves is nonparallel to a bottom of the reservoir.

The reservoirs have volumes of less than about 500 nanoliters.

Another aspect of the invention is a system for selective and directional centrifugation comprising at least one assay plate; an adapter; and a centrifuge wedge. The centrifuge wedge may have a thin corner, a thick corner, and two opposing intermediate corners spaced between the thin corner and thick corner. The adapter may be configured to securely engage both the assay plate and the centrifuge wedge.

The system may comprise at least one funnel dimensioned and configured to be complementary to the at least one assay plate. The at least one funnel is reversibly connectable to the at least one assay plate. The at least one funnel is a funnel array and the funnel array is positionable in the adapter. The at least one assay plate comprises a plurality of reservoirs, wherein each of the reservoirs comprises a spout and a plurality of shelves about a central axis.

The centrifuge wedge allows for the directional centrifugation of a specific shelf of the plurality of shelves, so that during a centrifugation a substrate on the specific shelf is deposited into the reservoir.

During the centrifugation substances on the other of the plurality of shelves is not deposited into the reservoir.

The details of various embodiments of the disclosure are set forth in the description below. Other features, objects, and advantages of the disclosure will be apparent from the description, drawings, and the claims. In the description, the singular forms also include the plural unless the context clearly dictates otherwise. Unless defined otherwise, all technical and scientific terms used herein have the same meaning as commonly understood by one of ordinary skill in the art to which this disclosure belongs. In the case of conflict, the present description will control.

### BRIEF DESCRIPTION OF THE DRAWINGS

The foregoing and other objects, features and advantages will be apparent from the following description of particular embodiments of the disclosure, as illustrated in the accompanying drawings. The drawings are not necessarily to scale, emphasis instead being placed upon illustrating the principles of various embodiments of the disclosure.

FIG. 1A is a partial perspective view of a first embodiment of a plate array 100.

FIG. 1B is a magnified view of inset 1B of FIG. 1A.

FIG. 1C is a magnified view of inset 1C of FIG. 1A.

FIG. 1D is a magnified view of inset 1D of FIG. 1A

FIG. 2A is a top perspective view of a second embodiment of a plate array 200.

FIG. 2B is a magnified view of inset 2B of FIG. 2A showing the shape of each individual reservoir 240 and a frame channel 232.

FIG. 2C is a top view of plate array embodiment 200.

FIG. 2D is a magnified view of inset 2D of FIG. 2C.

FIG. 2E is a partial side view of plate array 200 showing the shape of the reservoirs 240 with dashed lines.

FIG. 2F is a magnified view of inset 2E of FIG. 2F showing transition planes 247a,b, connectivity plane 245, spout 248 and spout vertex 246 with solid lines.

FIG. 3 is a top perspective view of a single reservoir 240.

FIG. 4A is a top view of reservoir 240 showing the same features of FIG. 3 and further with a rotation axis A plane P-1 and plane P-2.

FIG. 4B is a side elevation view of reservoir 240 representing a 90-degree rotation of axis A and indicating a first angle α between plane P-1 perpendicular to the interior base surface 243 of the reservoir 240 and the connectivity plane 245 central to the spout 248 and a second angle θ between plane P-2 perpendicular to the interior base surface 243 of the reservoir 240 and an interior sidewall 242 of the reservoir which does not form part of the spout 248.

FIG. 5 is a diagram in two steps (I and II) indicating geometric construction of the outer edge of reservoir 240.

FIG. 6A is a top view of another embodiment of a reservoir 340 which has a circular base 343 instead of the teardrop-shaped base 243 of reservoir 240.

FIG. 6B is a top perspective view of reservoir 340 of FIG. 6A.

FIG. 7 is a diagram in two steps indicating geometric construction of the outer edge of reservoir 340.

FIG. 8A is a top perspective view of a funnel array 360.

FIG. 8B is a side perspective view of the funnel array 360 of FIG. 8A.

FIG. 8C is a bottom perspective view of the funnel array 360 of FIGS. 8A and 8B.

FIG. 9 is a diagram indicating connection of a funnel array 360 to plate array 300 and collecting vessels 370a-d to the outlets 362a-d of funnels 361a-d of the funnel array 360.

FIG. 10A is a top perspective view of a funnel array 560, which may be used as a collection device.

FIG. 10B is a side perspective view of the funnel array 560, which may be used as a collection device of FIG. 10A.

FIG. 10C is a bottom perspective view of the funnel array 560, which may be used as a collection device of FIGS. 10A and 10B.

FIG. 11A shows the first three steps of a process for processing a single cell solution in reservoir 240.

FIG. 11B shows an additional three steps of a process for processing a single cell solution in reservoir 240.

FIG. 12A is a diagram indicating movement of a processed cell solution S-1 out of the reservoir 240 with centrifugation towards the interior surface of a funnel.

FIG. 12B is a diagram indicating movement of the processed cell solution S-1 along the interior surface of the funnel 266 after exit from the reservoir 240 for sample pooling.

FIG. 13A is a top view of plate array embodiment 400.

FIG. 13B is a magnified view of inset 13B of FIG. 13A.

FIG. 13C is a partial side view of plate array 400 showing the shape of the reservoirs 440 with dashed lines.

FIG. 13D is a magnified view of inset 13D of FIG. 13C showing transition planes 447a,b, connectivity plane 445, spout 448, spout ledge 451 and spout vertex 446 with solid lines.

FIG. 14 is a top perspective view of a single reservoir 440.

FIG. 15 is a diagram indicating dispensing of a reagent into a reservoir 440 which includes a spout ledge 451.

FIG. 16 is a diagram indicating how the reservoir embodiment 440 can be used to retain a reagent R-1 on the spout ledge 451, where it is reconstituted with a solvent and centrifuged to mix the reconstituted reagent R-1 with a second reagent at the bottom of the reservoir 440.

FIG. 17 is a diagram indicating dispensing of a single cell C in a reaction fluid R-3 onto the ledge 451 of the reservoir 440 followed by imaging while the single cell C remains on the ledge 451, prior to centrifugation to move the single cell C to the bottom of the reservoir 440.

FIG. 18A shows a schematic arrangement of a plane-focused arrangement of reservoirs where the vertex of the spout of each reservoir points in the same direction.

FIG. 18B shows a schematic arrangement of a point-focused arrangement of reservoirs where the vertex of the spout of each reservoir is directed to the same point.

FIG. 19 shows a top view, a side perspective, and a front perspective of an embodiment of a reservoir 1040 having a spout and a plurality of shelves.

FIG. 20 shows a more detailed top-down view of the reservoir in FIG. 19.

FIG. 21 is a diagram indicating how the reservoir embodiment 1040 can be used to delay an addition of a dehydrated reagent 1100 after other liquid reagents have been added to and mixed in the reservoir 1040.

FIG. 22 is a diagram indicating how the reservoir embodiment 1040 can be used to perform an in-well assay using reporter probes 1100 and capture probes 1102 dehydrated on different shelves in order to capture and report cellular products.

FIG. 23 is an exemplary diagram for a single cell clean-up assay performed in the reservoir embodiment 1040 in order to capture cellular components

FIG. 24A is a top plan view of a plate 2300 and frame 2210 containing embodiments of the reservoir 1040.

FIG. 24B shows a top and bottom perspective view of an embodiment of adapter 2200 and funnel arrays 2360.

FIG. 25 shows a top plan and side view of a wedge 2000 for centrifuging the reservoir embodiment 1040.

FIG. 26A shows a combination of the frame 2210 in a transverse orientation in the adapter 2200 and a wedge 2000.

FIG. 26B shows a combination of the frame 2210 in a longitudinal orientation in the adapter 2200 and a wedge 2000.

FIG. 27 is an exemplary diagram for selective centrifugation using an embodiment of the reservoir 1040 and utilizing a wedge 2000 and adapter 2200 in order to selectively chose a reagent on a specific shelf to introduce to the interior base surface 1043 of the reservoir 1040.

FIG. 28 shows an embodiment of reservoir 2540 with rounded shelves 2501.

FIG. 29 is an exemplary diagram for cell entrapment.

FIG. 30 is an exemplary diagram for a washing method for matric-bound cells.

FIG. 31 is an exemplary diagram of cell colocalization using an embodiment of the nanovessel and adapter 2200 and wedge 2000.

FIG. 32 is an exemplary diagram of magnetic capture beads in use in the embodiment of the nanovessel.

FIG. 33 is an exemplary diagram of magnetic mixing beads in use in the embodiment of the nanovessel.

FIG. 34 is an exemplary diagram depicting cell product media transfer to a planar array using an embodiment of the nanovessel.

FIG. 35 is a workflow diagram of using the cellenRNA kit.

FIG. 36 is a chart which provides the sequence data metrics that were calculated for human single cells from the HEK cell line. The box boundaries indicate 25th and 75th percentiles, the center line represents the median, cross indicates the mean, whiskers shows +−1.5×interquartile range, and points are actual values of outliers, with n=36 for Rep_1 and n=34 for Rep_2.

FIG. 37 is a chart which shows that the number of mapped reads per UMI were calculated for human single cells (left boxplot), mouse single cells (2nd boxplot), 5 human cells (3rd boxplot), and for 5 mouse cells (right boxplot). The box boundaries indicate 25th and 75th percentiles, center line represents the median, cross indicates the mean, whiskers shows +−1.5×interquartile range, and points are actual values of outliers, with n=36 for Rep_1 and n=35 for Rep_2.

FIG. 38 is a chart showing the percentage of reads per cell that uniquely mapped to human genome (left panel) or mouse genome (right panel) for human single cells (left boxplot), mouse single cells (2nd boxplot), 5 human cells (3rd boxplot), and for 5 mouse cells (right boxplot).

FIG. 39 is a chart showing the number of detected genes per cell for human single cells (left boxplot), mouse single cells (2nd boxplot), 5 human cells (3rd boxplot), 5 mouse cells (4th boxplot), human single cells without RTase (5th boxplot), no cells and no culture medium (6th boxplot), no cells with culture medium (7th boxplot), and for human single cells with Rnase (right boxplot). The box boundaries indicate 25th and 75th percentiles, center line represents the median, cross indicates the mean, whiskers shows +/−1.5×interquartile range, and points are actual values of outliers, with n=36 for Rep_1 and n=35 for Rep_2.

### DETAILED DESCRIPTION

### I. Introduction

The present inventors, being engaged in development of nanoscale devices and instrumentation for processing biomolecules and printing single cells have made a number of technological advances in single cell printing devices, such as for example, the devices described and claimed in commonly owned European Patent Application Publication No. EP3222353 and European Patent Application No. EP17189875 (each incorporated herein by reference in entirety). Such advances are expected to lead to development of additional efficiencies in a number of nano-scale assays such as various different types next generation sequencing, gene expression analyses and proteomics analyses of single cells. In the process of customization of various assays, the inventors have recognized certain shortcomings in conventional sample plates designed for use with samples at the micro and nano-scale level. At the nano-scale, capillary action is an important contributor in determining flow of fluids into and out of sample reservoirs. In particular, problems arise during sequential dispensing of various reagents into such nano-scale reservoirs, which may prevent the desired mixing or cause undesirable contamination. For example, the inventors have discovered that dispensing of picoliter volumes into conventional nano-scale reservoirs will occasionally and consistently result in ejection of fluids from such reservoirs. This is a problematic occurrence because it will result in cross-contamination between reservoirs of a plate. Development of the shaped reservoirs and loading methods described herein has been found effective in addressing this problem.

In addition, the same issues arise when removing samples from such reservoirs in situations where sample pooling is desired. The inventors have discovered that providing plate reservoirs which are individually shaped and aligned with each other will improve the flow of fluids into and out of the individual reservoir. This provides significant advantages in processing of samples at the nanoscale level. The advantages provided by the embodiments described herein are expected to be applicable to essentially any assay requiring dispensation of single cells, biomolecules, fluids, particles, reagents and solutions at the micro-, nano-, and pico-scale level.

The details of embodiments of the invention are set forth in the accompanying description below. Although any materials and methods similar or equivalent to those described herein can be used in the practice or testing of the present invention, the preferred materials and methods are now described. Other features, objects and advantages of the invention will be apparent from the description. In the description, the singular forms also include the plural unless the context clearly dictates otherwise. Unless defined otherwise, all technical and scientific terms used herein have the same meaning as commonly understood by one of ordinary skill in the art to which this invention belongs. In the case of conflict, the present description will control. A number of alternative features will be introduced during the course of describing various embodiments. Such alternative features may be combined to produce specific combinations which may not be described explicitly herein. Nonetheless, such alternative embodiments are within the scope of the invention. In the description below, similar reference numerals are used as identifiers of similar features in most cases.

### II. Array Plate with Shaped Reservoirs

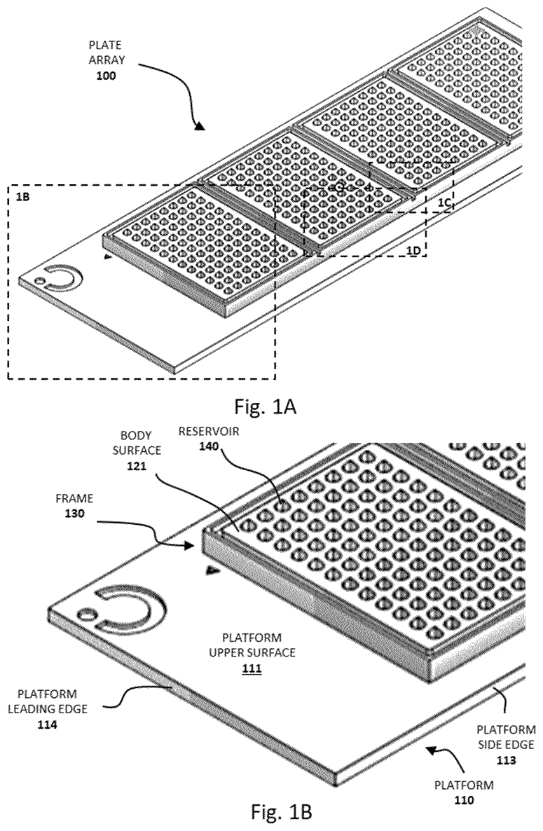

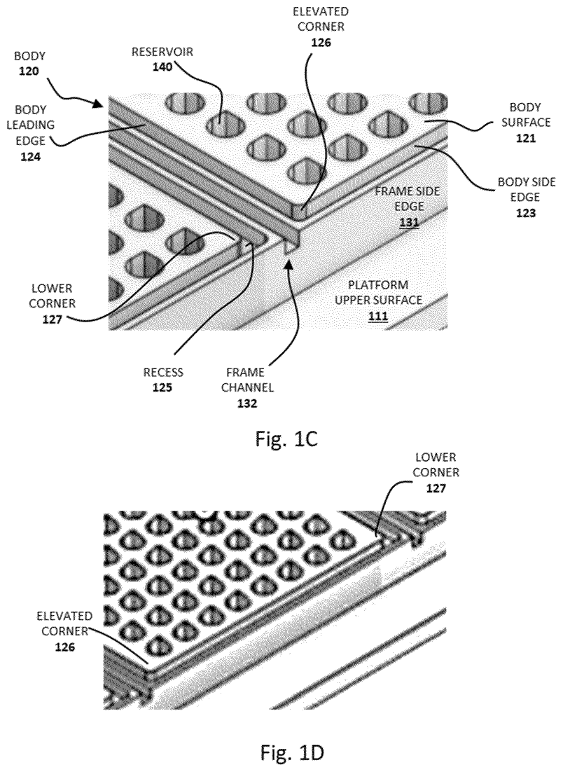

Turning now to FIGS. 1A to 1D, there is shown a first embodiment of a plate array 100, which includes four plates as shown, each having 96 reservoirs formed therein in a general configuration similar to a conventional 96-well microtiter plate (8×12 reservoirs). Alternative embodiments may have fewer or more reservoirs and/or fewer or more plates. The reservoirs 140 of this embodiment are nano-vessels, meaning that they are configured to hold nanoliter volumes. However, the features of this embodiment may also be used in plates configured to hold microliter or picoliter volumes. The four plates of the present embodiment are each formed with a rectangular body 120 which is supported on or formed integrally with frame 130 on the upper surface 111 of a platform 110 having a leading edge 114, side edges 113 and a back edge which is not visible in the views shown). As noted, the upper body surface 121 of each plate has 96 reservoirs formed therein, each identified by reference numeral 140 as seen in FIGS. 1B and 1C. Thus, the plate array 100 with four plates includes a total of 384 reservoirs 140.

FIG. 1C is a magnified portion of FIG. 1A showing an edge area between two plates showing the edge 131 of the frame 130. The view shown in FIG. 1C indicates that the upper surface of the body 120 of each plate is sloped downward from an elevated corner 126 to lower corners 127 (in this view a lower corner of the left-middle plate (in the view shown) is opposite the elevated corner 126 of the adjacent plate to the right. FIG. 1D is a magnified view of one end of a single plate, indicating the elevated corner 126 and its front adjacent lower corner 127. Thus, each plate slopes downward from its elevated corner to provide one possible mechanism for improvement of draining of samples from the reservoirs 140, representing one feature of the invention. Other mechanisms will be described hereinbelow with respect to additional embodiments.

Additional features of the plate array 100 include frame channels 132 formed in the frame 130 between the plates and a recess 125 partly surrounding each plate. Thus, at the elevated corners 126 of each plate, the recess 125 is absent but as each plate slopes downward, it transitions to becoming partially circumscribed by the recess 125. As seen in FIG. 1C, the recess 125 is visible at areas adjacent to the lower corner 126 of the left middle plate, while the recess 125 is not seen circumscribing the adjacent plate in this view. Instead, the leading edge 124 of the body 120 and the side edge 123 of the body 120 is seen to be above the upper surface of the frame 130.

The recess 125 provides structure for connection of a recovery funnel (not shown) having a complementary recess-coupling ridge-like structure to facilitate drainage of the contents of the reservoir 140. An alternative embodiment described hereinbelow will be used to highlight the features of an array of recovery funnels.

It is to be noted that each of the reservoirs 140 is teardrop-shaped. All of these reservoirs are aligned with the teardrop vertex pointing away from the elevated corner 126 of each plate and towards the opposite corner. When the contents of the reservoirs are being removed by centrifugation, liquids are induced to drain into a recovery funnel in a direction opposite the elevated corner, exiting each reservoir at the vertex. Each reservoir 140 promotes draining from the bottom of the well where the capillary meets it to the top of the well. The fluid is encouraged to move via both centrifugal force and capillary force along the capillary. Once reaching the top of the well the fluid separates from the top surface.

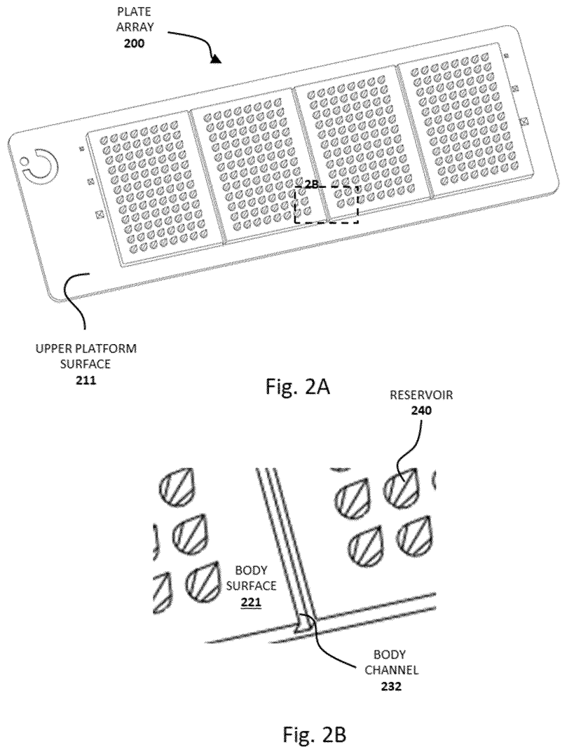

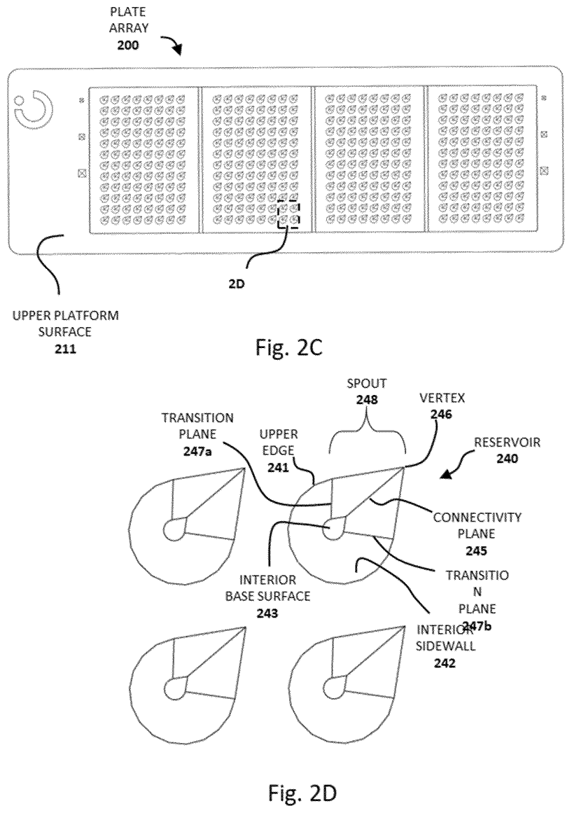

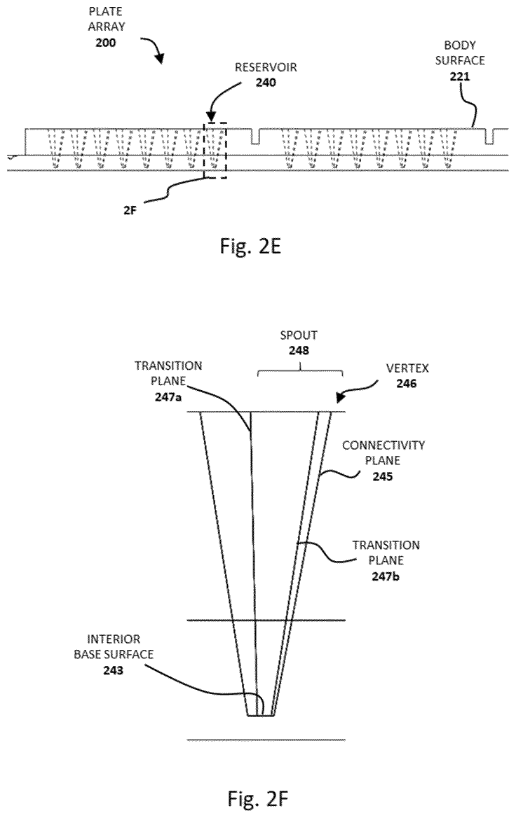

Turning now to FIGS. 2A to 4B, there is shown a second embodiment of a nano-vessel plate array 200 configured with four plates on an upper platform surface 211. This embodiment 200 differs from the plate array 100 described above, in having four plates which are not sloped. The upper surfaces of each plate are substantially horizontal with each of the four corners at substantially the same level. In addition, plate array 200 does not have a partially circumscribing recess as included in plate array 100.

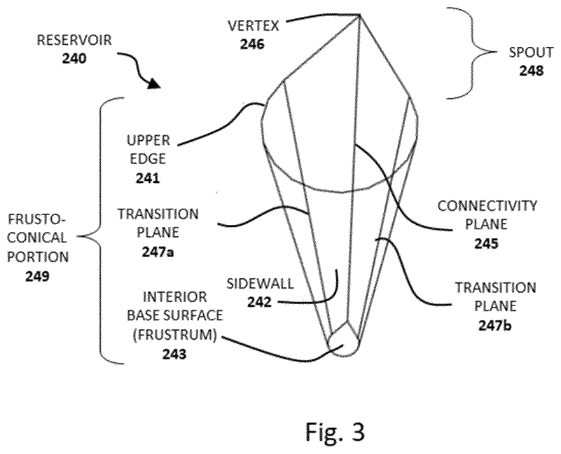

In plate array 200, the reservoirs 240 are also teardrop shaped. In the top views of four reservoirs 240 in FIG. 2D (representing a magnified inset of FIG. 2A) and particularly in the side views of FIGS. 2E and 2F, it is seen that each of the reservoirs 240 is tapered inwards towards its teardrop-shaped base surface 243. While the side elevation views of FIGS. 2E and 2F provide the general appearance of a cone-shaped reservoir 240, the perspective view of FIG. 3 more clearly indicates that each reservoir 240 is pitcher-shaped with a frustoconical portion 249 transitioning at planes 247a,b to form a spout portion 248 terminating at vertex 246 which is aligned with connectivity plane 245. Thus, most of the upper edge 241 of the reservoir 240 is circular with a transition to a straight line to the vertex 246 at each transition plane 247a,b.

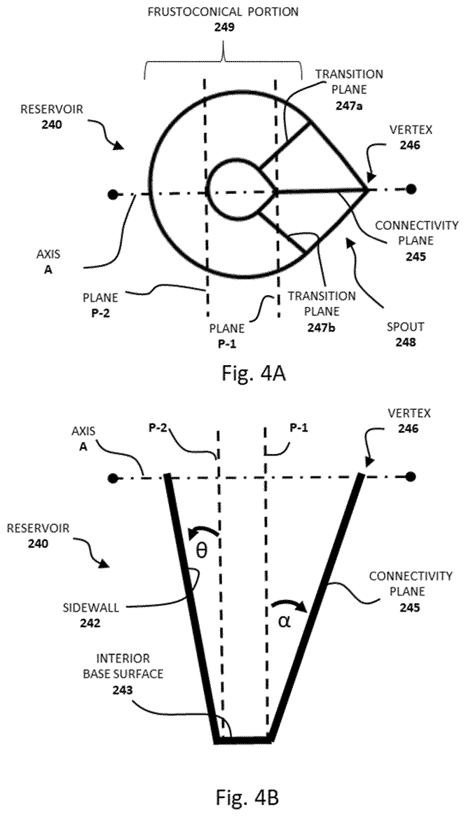

This pitcher-shaped reservoir 240 is defined by having a sidewall 242 with a slope transitioning from a steeper slope to more gradual slope at the spout portion 248 as shown in FIG. 4B, which represents a cross-sectional side view of the reservoir 240 as generated by a 90-degree rotation of the top view of reservoir 240 along axis A of FIG. 4A. FIG. 4B demonstrates that the angle α between a perpendicular reference plane P-1 intersecting the edge of the base 243 closest to the vertex 246 and the connectivity plane 245 is greater than the angle θ between a perpendicular reference plane P-2 intersecting the edge of the base 243 in the frustoconical portion 249 and the interior sidewall 242 of the frustoconical portion 249.

This pitcher-shaped reservoir 240 has been found to be an effective reservoir shape to provide improvements in processes for dispensing fluids into the reservoir 240 and removal of sample fluids contained therein.

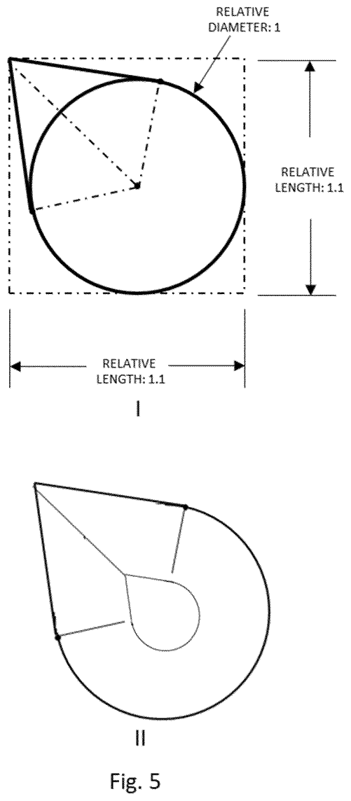

FIG. 5 is a diagram indicating one possible process for generating the geometric shape of the upper edge 241 of reservoir 240 and the shape of the reservoir 240 itself. This process is provided by way of example only. Other processes for generating this geometric shape and variant embodiments thereof may be used. First, a circle having a relative diameter of 1 is provided. The circle is placed within a square with sides having equal relative dimensions of 1.1 such that the circumference of the circle is offset from the center of the square and meets adjacent sides of the square. However, other relative dimensions are contemplated in order to efficiently create a reservoir 240 with appropriate capillary action. The corner of the square farthest from the circumference of the circle is defined as the vertex of the shape and a line is drawn from the center of the circle to the vertex (this line is aligned with the plane of connectivity 245). Next, a pair of points is identified along the circle such that a pair of equivalent triangles is defined by the center of the circle, the vertex and lines drawn between the pair of points and the vertex. The lines between the pair of points and the center of the circle represent the transition planes 247a,b and a line drawn between the center of the circle and the vertex represents the plane of connectivity 245 as noted above. Finally, in a third dimension, a base having the same shape but smaller dimension as the outer edge is placed centrally within the outer with aligned vertices at an appropriate distance below the outer edge, thereby defining sidewalls of the reservoir. The distance of the base from the outer edge of the reservoir and the size of the base will define the volume of the reservoir.

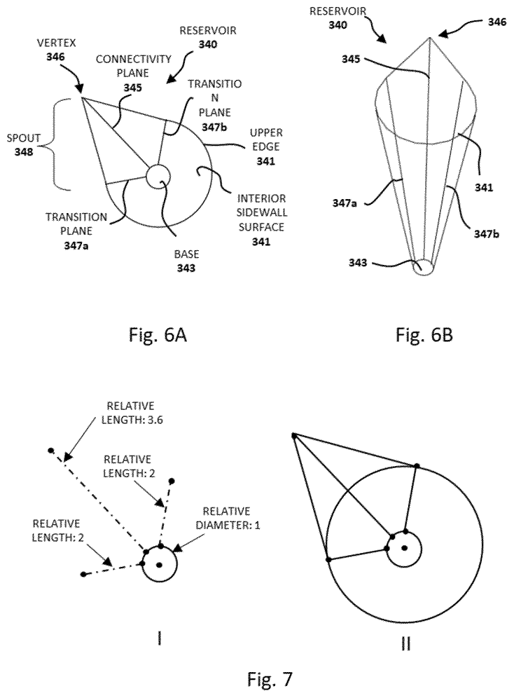

Turning now to FIGS. 6A and 6B, there are shown top and perspective views of an alternative reservoir embodiment 340 which is generally similar to reservoir embodiment 240 but differs in being provided with a circular base 343 instead of the teardrop-shaped base 243 of reservoir 240 in plate array 200. Otherwise, the teardrop-shaped upper edge 341, the transition planes 347a,b, the plane of connectivity 345, the vertex 346 and the spout 346 are generally arranged in a similar manner as described for reservoir embodiment 240. This reservoir embodiment 340 may be incorporated into a plate array such as plate array 100 or plate array 200 for example.

Functionally, this reservoir embodiment 340 differs from reservoir embodiment 240 in providing a more readily predictable flow pattern as a result of having a base with a uniformly circular base as well as being more reliably formed by 3D-printing or hot embossing. Alternative embodiments have bases with different shapes and dimensions. It is expected that a reservoir with a base having a reduced base surface area will provide certain advantages, such as functionality in concentration of fluids.

FIG. 7 shows one possible process for constructing the geometric shape of reservoir 340. Starting with a small circle of relative diameter of 1, a single line of relative length of 3.6 is lofted from this small circle to end at the vertex point. Then a pair of lines of relative length of 2 equidistant from the single line along the circumference of the circle are lofted outwards from the small circle. A large circle is centralized over the small circle such that the ends of the pair of lines meet the circumference of the large circle. At these meeting points, lines are drawn to meet the vertex to define the pointed end of the upper edge of the reservoir 340. With a third-dimension distance being defined between the small circle and the large circle, sidewalls of the reservoir 340 are defined, thereby defining the volume of the reservoir 340.

### III. Plate Array and Funnel Array Assembly for Pooling Samples

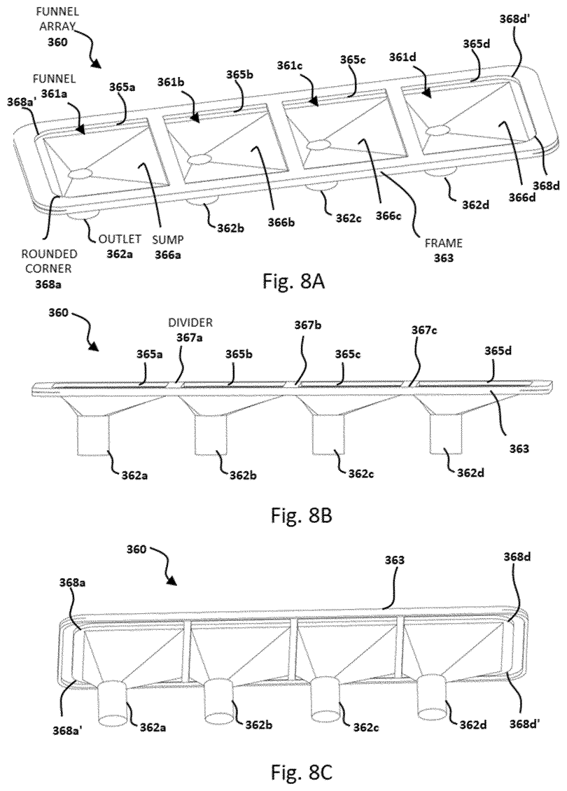

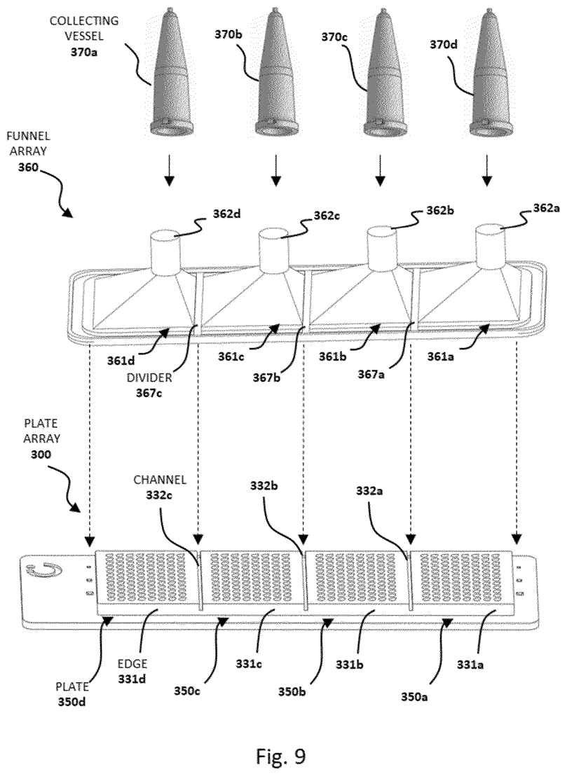

FIGS. 8A to 8C, FIGS. 9 and 10A to 10B illustrate features providing sample pooling functionality. FIGS. 8A to 8C show different perspective views of a funnel array 360 which is used to collect and pool samples contained in individual reservoirs 340 on the plates 350a-d of plate array 300, as shown in FIG. 9. Pooling of samples is done in assay situations where it is desirable to have a greater volume of a sample for subsequent analysis. For example, a first plate 350a of a plate array 300 may include the same type of cell in all of its operating reservoirs 340 where processing of the cell solution may be performed. Following processing of the solutions in the reservoirs 340, the contents of the reservoirs in this plate 350a can be pooled and collected using funnel 361a of the funnel array 360.

In FIGS. 8A to 8C, it seen that the funnel array 360 includes four generally rectangular funnels 361a-d which are formed in an array frame 363 such that each funnel 361a-d extends below the upper surface of the array frame 363. Each funnel 361a-d has a sump 366a-d formed of four sloped surfaces extending downwards from each side of the funnel 361a-d, leading to a drain outlet 362a-d.

The frame 363 of the funnel array 360 includes three transverse dividers 367a-c (best seen in FIG. 8B) which are integrally formed with the frame 363 and have upper surfaces which are coplanar with the upper surface of the frame 363. In an alternative embodiment, an additional function of the dividers 367a-c is to provide a coupling structure operating with a complementary coupling structure on the plate array 350. For example, the dividers could engage with appropriately dimensioned respective channels 332a-c between the plates.

It is seen in FIG. 8B that divider 367a forms a barrier between funnels 361a and 361b. If an assay was performed in the reservoirs 340 of two adjacent plates 350a and 350b with a first cell type in plate 350a and a second cell type in plate 350b, the pooled samples collected by funnels 361a and 361b would provide two distinct pooled samples each containing a specific cell type. In this embodiment, if sample fluid moving from a reservoir 340 to its respective funnel is incidentally induced to flow outwards via capillary action between the upper body surface 321 of the plate array 300 and the surface of the dividers 367a-c, of the funnel array 360, the capillary flow will be halted by the wider area at the channels 332a-c. This prevents cross-contamination between the funnels 361a-c.

In this embodiment, each funnel 361a-d has an upper portion with a relatively narrow vertical sidewall 365a-d which engages the side edges 332a-d of the plates 350a-d when the funnel array 360 is connected to the plate array 300. This provides an additional press-fit frictional engagement coupling mechanism to connect the funnel array 360 to the plate array 300.

The funnel array 360 has funnels 361a and 361d with rounded corners 368a, 368a′, 368d, and 368d′ to fit the corners of end plates 350a and 350d of the plate array 300. In this embodiment, the rounded corners are substantially similar. However, an alternative embodiment (not shown) of the funnel array 360 and plate array 300 assembly has a single uniquely-shaped corner at any one of the four locations in the funnel array 360 and in the plate array 300. This will ensure that complementary connection of the funnel array 360 to the plate array 300 will be made in a proper orientation with the vertices and spouts of the reservoirs 340 of each plate 350a-d being directed towards the corner closest to the outlet of each connected funnel 361a-d of the funnel array 360. This alternative embodiment is particularly advantageous because the reservoirs 340 of the plate array 300 are small and it is challenging to identify the vertices and spouts of the reservoirs in order to ensure that they point towards the outlets 362a-d of the funnel array 360. The single set of unique corner couplings would prevent the funnel array 360 from being connected to the plate array 300 in an incorrect orientation where the vertices and spouts of the reservoirs 340 on the plate array 300 point away from the outlets 362a-d of the funnels 361a-d, as an attempt to make such a connection would fail as a result of incorrect matching of complementary corners on the plate array 300 and the funnel array 360. In an alternative embodiment, instead of providing a single set of uniquely matched corners, a visual indicator such as matched marking signs on the funnel array 360 and plate array 300 could be provided to instruct a user to connect the funnel array 360 to the plate array 300 in the proper orientation.

As noted above, FIG. 9, shows an arrangement for coupling the funnel array 360 to the plate array 300 for pooling of samples from plates 350a-d. Plate array 300 is similar in construction to plate array 200 with the exception of having reservoirs 340 formed therein, which have a teardrop shaped upper edge 341 and a circular base 343. It is seen in FIG. 9, that the funnel array 360 is placed over the plates 350a-d of the plate array 300.

Collecting vessels 370a-d are connected to the outlets 361a-d of the funnel array 360. This assembly is placed in a separate housing (not shown) designed to rigidly retain the assembly within a centrifuge such that during centrifugation, with the plate array 300 placed upside down, fluids contained within each reservoir 340 are induced to flow out of the reservoir 340 via the spout 348, through the respective funnels 361a-d and outlets 362a-d and into the collecting vessels 370a-d. It is to be understood that all 96 wells of each plate 350a-d will be pooled together into respective collecting vessels 370a-d. Therefore, it is possible to conduct an experiment with four separate conditions or sample components in the four separate plates.

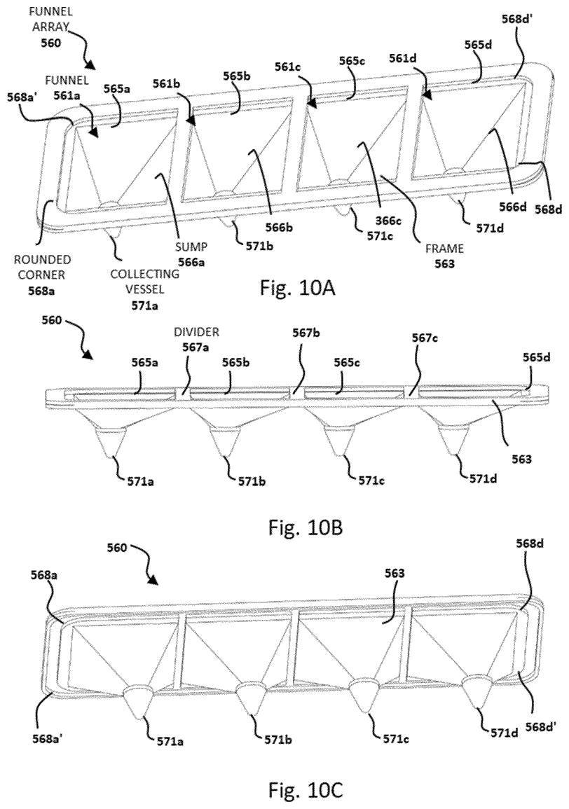

Referring now to FIGS. 10A to 10C, there is shown another funnel array embodiment 560 where similar reference numerals indicate similar features. Like funnel array embodiment 360, funnel array embodiment 560 includes an array frame 563 with inner rounded corners 568a, 568a′, 568d and 568d′, having four funnels 561a-d formed therein. Each of the funnels 561a-d has a vertical sidewall 565a-d and a sump 566a-d. However, instead of an outlet at the bottom of each funnel 561a-d, there is an integrally formed conical collecting vessel 571a-d which can be used for subsequent sample manipulations, rather than requiring a step of transferring samples from the four funnels 561a-d into separate collecting vessels (as shown for funnel array 360 in FIG. 9).

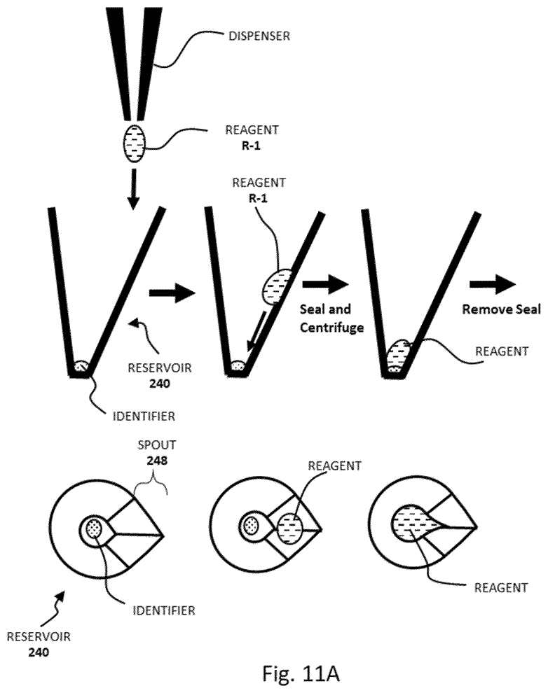

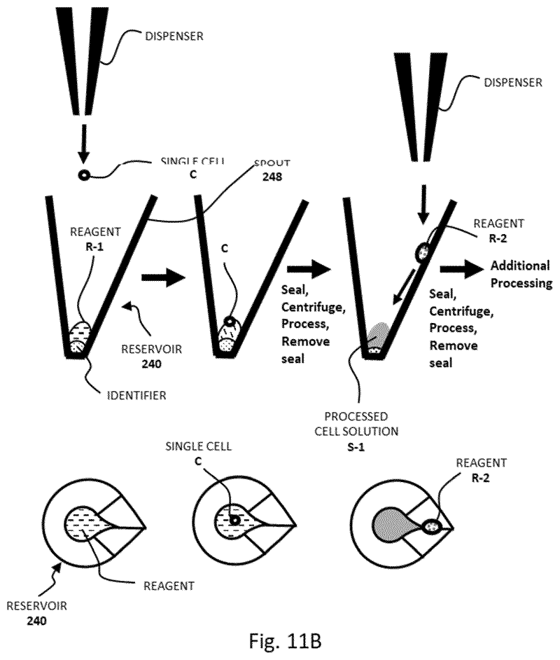

Turning now to FIGS. 11A and 11B, an example of a series of steps of loading reagents and a single cell into a reservoir 240 on plate 200 for a generalized assay. In these diagrams, side cross-sectional views similar to the view shown in FIG. 4B and top views similar to the view shown in FIG. 4A are shown to highlight the advantages of the features of the reservoir 240 which is pre-loaded with a nucleic-acid based molecular identifier. The molecular identifier (sometimes referred to as a “barcode”) is provided for identifying each specific reservoir 240 of the array plate 200. The molecular identifier will have a sequence segment that is unique to for a specific reservoir 240. In some embodiments, the molecular identifier further includes a random set of nucleobases which is known as a unique molecular index for counting copies of genes or transcripts that have been captured. In some embodiments, the molecular identifier also includes a sequence used to capture a known part of the target of interest. In some embodiments, the molecular identifier is a nucleic acid segment of a length of about 16 to about 30 nucleobases. In other embodiments, in applications such as proteomics analyses, the molecular identifier is an isotope tagged chemistry which is identified by mass spectrometry. In other embodiments the molecular identifier is formed of another identifiable material for mapping data from downstream analysis back to the cell/particle/material dispensed into the reservoir.

A reagent R-1 is dispensed from a dispenser into the reservoir 240 containing the molecular identifier and lands onto the spout side of the reservoir 240 where the reagent is held by capillary force adhesion. In the next step (which would occur after dispensing the reagent into additional reservoirs 240), the array plate 200 is sealed and placed in a centrifuge housing (not shown) and centrifuged to move the reagent to the base of the reservoir 240. In the next step (FIG. 11B) a single cell C is dispensed directly into the reservoir such that it lands directly on top of the reagent R-1. At this point, the plate array 200 may be sealed and centrifuged again, if needed to properly suspend the cell C in the reagent R-1 thereby providing a processed cell solution S-1. In alternative embodiments, physical forces other than centrifugal forces are employed to move the reagents downward. Examples of such forces include, but are not limited to vibrations, electrostatic forces, or others. In one example, dielectrophoresis is employed to induce movement of the reagents. Electromagnetism is used to move or control fluids with embedded or dissolved magnetic particles. In some cases, after the cell is dispensed, a centrifugation/mixing step is not required. In the next step, a second reagent R-2 is dispensed onto the spout portion of the reservoir 240 in a manner similar to the dispensation of reagent R-1. This step is followed by centrifugation again to properly mix reagent R-2 into the processed cell solution S-1 in subsequent processing steps which may include dispensing of additional reagents into the reservoir 240 for the assay. It is to be understood that the pitcher shaped reservoir 240 provides a wider opening to allow solution components, biomolecules, cells and other particles to be dispensed at different locations in the reservoir, at least on the spout or directly towards the base of the reservoir 240. In a typical parallel loading protocol, reagents are added into/onto each reservoir spout 248, prior to centrifugation. The reagents then may be added at the same time to all reservoirs 240, in a single plate or all plates of the plate array, 200, during centrifugation. In other words, in this sequence, reagents may be first added to the spouts 248 sequentially, but then all reaction vessels or reservoirs 240 are loaded with the same reagents at the same time, during centrifugation. While not shown in FIGS. 11A and 11B, it is to be understood that if dispensers are provided at a sufficient scale, it may be possible to provide simultaneous or substantially simultaneous parallel addition of different components to a given reservoir 240. In some situations, a larger volume of dispensed reagent might result in adhesion across the entire reservoir 240 before it can drop to the bottom of the reservoir 240 or smaller volumes may run down the spout to the bottom of the reservoir 240. In any case, the centrifugation step will ensure that the reagent is properly contained within the reservoir 240 and/or mixed with other components as appropriate. The shape of the reservoir 240 thus provides the advantage of efficiency and flexibility in design of a dispensation protocol. For example, reservoirs of conventional nano-scale plates with narrower openings may not be sufficiently wide to permit parallel dispensation of components. Such a dispensation protocol may be easily implemented using the plate array 200.

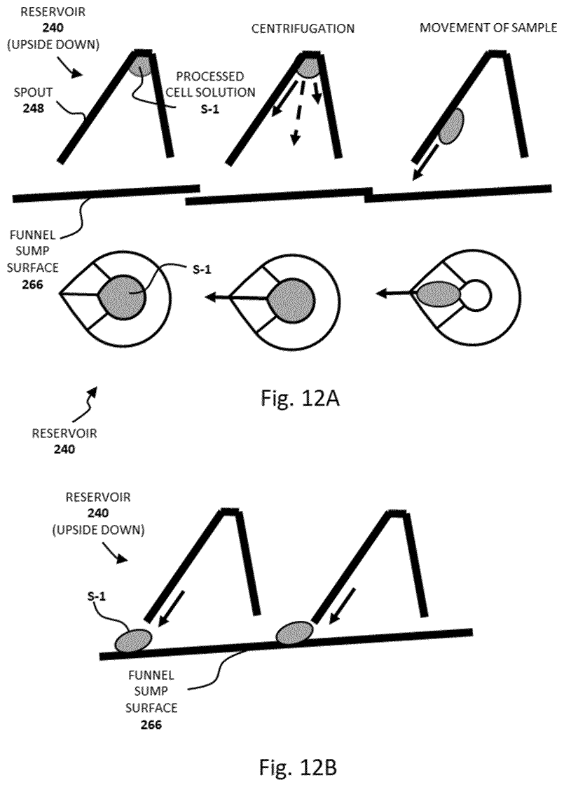

Turning now to FIGS. 12A and 12B, a general process for removal of a processed solution with pooling of samples contained within reservoirs 240 of a single plate is shown using side cross-sectional and top views similar to those used in FIGS. 11A and 11B. As noted above, with respect to the plate array embodiment 300 (FIG. 9) recovery of samples from the plates of a plate array assembly includes arranging the plate array upside down in a centrifuge housing. Thus in FIG. 12A, the reservoir 240 is shown in an inverted orientation facing towards the sloped interior funnel surface, where at first, the processed solution S-1 remains adhered to the base of the reservoir 240. Next, the plate array 200 is placed in a centrifuge housing (not shown) and subjected to appropriate centrifugation to induce the processed solution S-1 to move out of the reservoir 240 and into the connected funnel where it encounters the surface of the funnel sump 266. As noted above, other forces such as controllable vibrations or controllable electrostatic forces may be used as alternatives to centrifugation. In this step, centrifugal forces (indicated by the short arrow) and capillary forces (indicated by the left longer arrow) act on the processed solution S-1 to draw it from the bottom of the reservoir 240, toward the vertex of the spout 248 as shown. The dashed line represents the two forces combined. In FIG. 12B, two adjacent reservoirs 240 are shown with processed solutions S-1 having exited the reservoirs 240 with movement along the interior surface of the funnel sump 266. While not shown specifically in FIG. 12B, it is to be understood that the processed samples S-1 merge and are pooled with recovery being made via the funnel outlet leading to a collecting vessel as shown in FIG. 9. As noted above, in alternative embodiments, forces other than the forces provided by a centrifuge are used to induce movement of the samples out of the reservoirs 240. Such forces may include, but are not limited to, vibrations, electrostatic forces and rapid heating to form bubbles causing movement of a droplet in a manner similar to inkjet printers.

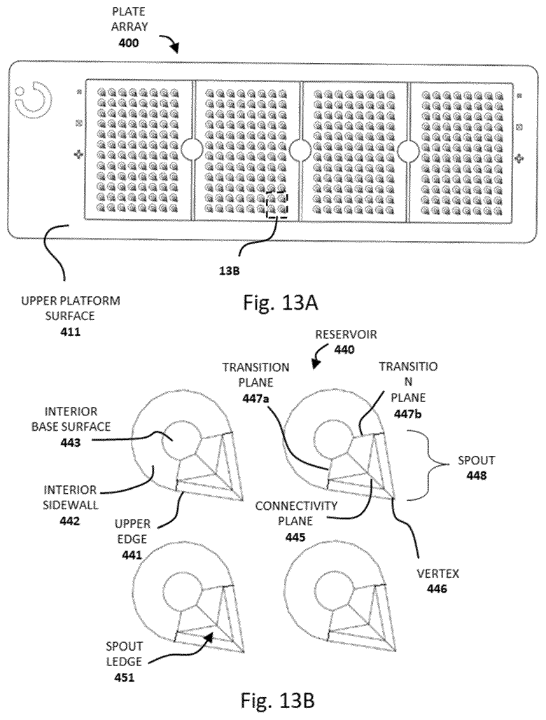

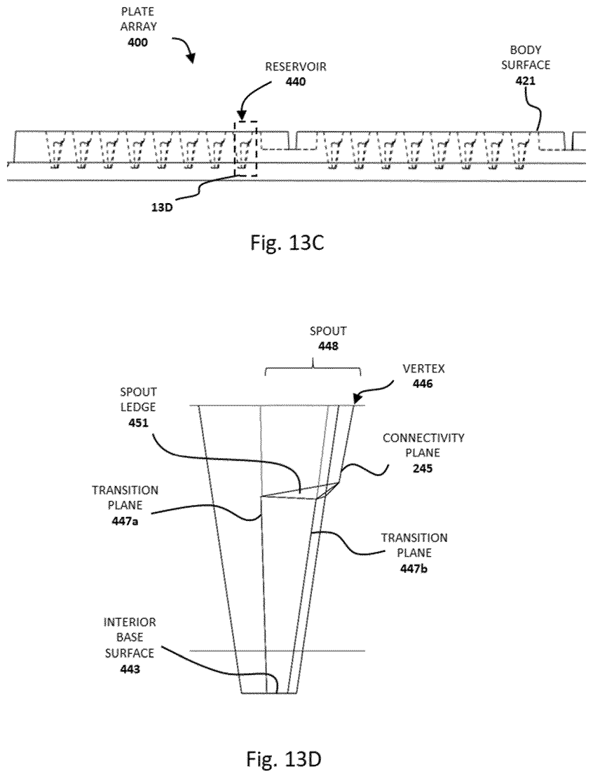

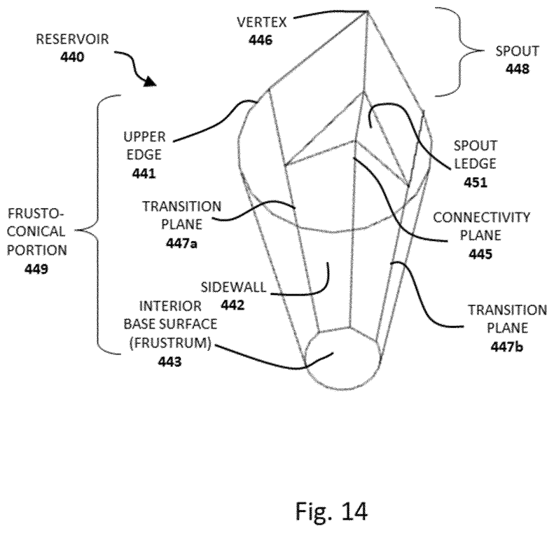

Referring now to FIG. 13A, there is shown another plate array embodiment 400 with a number of similar features shown in plate array embodiments 200 and 300. The plate array 400 has an upper platform surface 411 supporting a body having four plates formed therein with each plate having 96 reservoirs 440 with features shown in different views in FIGS. 13B to 1D and FIG. 14. The top view of four adjacent reservoirs 440 shown in FIG. 13B indicate that each reservoir has an interior base surface 443, an interior sidewall 442, an upper edge 441, a pair of opposed transition planes 447a,b and a connectivity plane 445 which together form a spout 448 with vertex 446 with dimensions distinct from the remaining frustoconical portion 449 of the reservoir 440. These features are similar to the analogous features of reservoir 240 of plate array 200 and reservoir 360 of plate array 300 (FIG. 2D). One difference is that reservoir 460 has a ledge 451 formed in the spout 448 which in this embodiment has a slope which is shallower than the slope of the remaining portions of the spout 448. Additional views of reservoir 440 are shown in FIGS. 13C to 13D and 14.

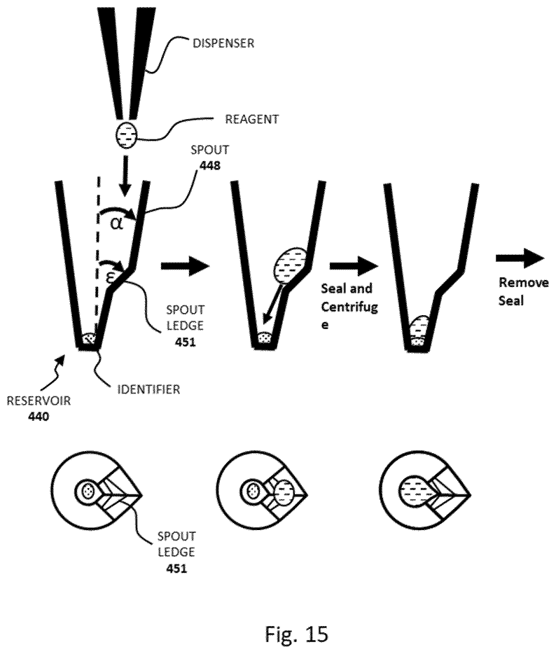

FIG. 15 shows reservoir embodiment 440 in side cross-sectional and top views similar to the views of FIGS. 11A, 11B, 12A and 12B. This reservoir embodiment 440 is provided with a spout ledge 451. FIG. 11A shows that spout ledge 451 is a portion of the spout 448 which is provided at a greater angle c with respect to the angle α as described for FIG. 4B. FIGS. 15 to 17 indicate that the spout ledge 451 provides for a greater extent of retention of a reagent on the spout 448. This may be advantageous in certain situations where parallel dispensation of two reagents is performed simultaneously or substantially simultaneously, where it is desirable to have one reagent move to the bottom of the reservoir first with the other reagent remaining on the spout ledge 451 until the centrifugation step. FIG. 15 shows a step of dispensing a reagent into the reservoir 440 resulting in the reagent first resting on the ledge 451 before it is induced to move to the bottom of the reservoir by centrifugation for subsequent processing.

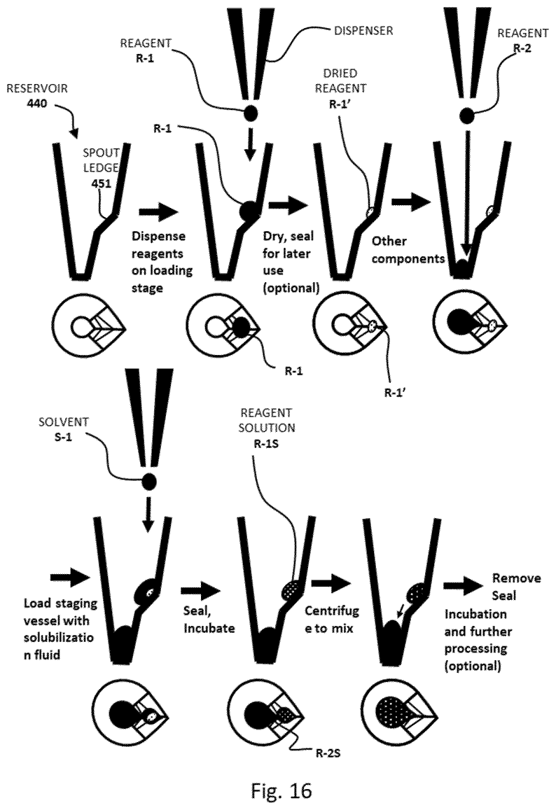

FIG. 16 illustrates how the reservoir 440 can be used to manipulate a reagent R-1 placed on the spout ledge 451 by a dispenser. In situations where reagent R-1 is unstable in solution form or for any other reason, the reagent R-1 resting on the ledge 451 can be dried in place (generating dried reagent R-1′) and the reservoir 440 can be sealed and stored for later use. When the user is ready to conduct an assay, a second reagent R-2 can be dispensed to the bottom of the reservoir 440 and the dried reagent R-1′ can be reconstituted with a solvent S to form a reconstituted reagent solution R-1S. In the next step, the reconstituted reagent solution R-1S is induced to move to the bottom of the reservoir by centrifugation for mixing with reagent R-2.

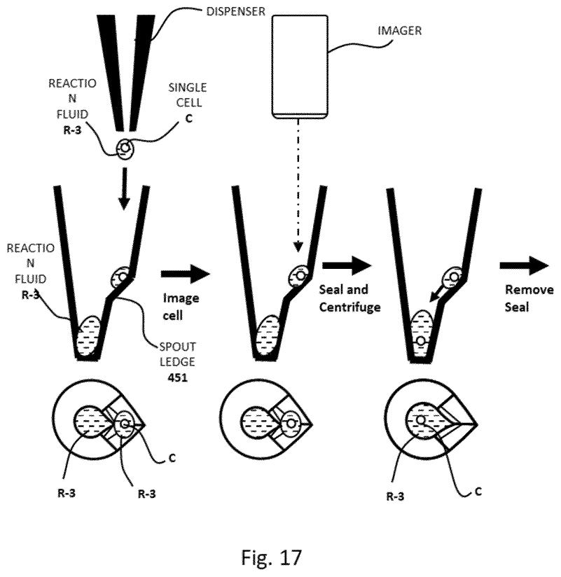

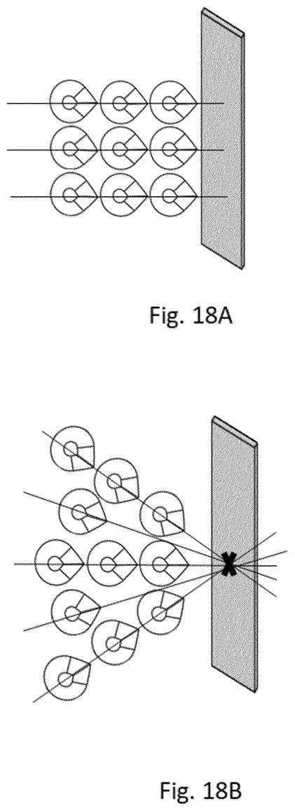

FIG. 17 illustrates how a single cell C suspended in reaction fluid R-3 can be dispensed onto the ledge 451 and imaged thereon prior to inducing the suspended cell C to move to the bottom of the reservoir by centrifugation for subsequent processing.

Turning now to FIGS. 18A and 18B, there are shown two possible arrangements for orientation of individual reservoirs on a plate. The reservoirs are shown with top views to indicate the orientation of the vertices of the reservoirs. FIG. 18A has all reservoirs with vertices co-aligned in an orientation perpendicular to the plane shown. This represents the arrangement used in array plate embodiments 100, 200 and 300 described hereinabove. FIG. 18B illustrates a different arrangement wherein all reservoir vertices are directed towards a single point shown centrally on the plane. It is seen in this arrangement that the reservoirs require additional spacing between each other to account for the different orientations of the vertices.

### IV. Plate Arrays in Nano-Scale Assays

The massive parallelization of biological assays and realization of single-molecule resolution have yielded profound advances in the ways that biological systems are characterized and monitored and the way in which biological disorders are treated. Assays are used to interrogate thousands of individual molecules simultaneously, often in real time. These biochemical and medical assays often rely on the accurate and precise positioning of individual assay components on a molecular scale. Thousands of nanoscale assays are often patterned on a substrate for macro-manipulation, analysis, and data recording.

The combination of solid-state electronics technologies to biological research applications has provided a number of important advances including DNA arrays (see, e.g., U.S. Pat. No. 6,261,776, incorporated herein by reference in its entirety), microfluidic chip technologies (see e.g., U.S. Pat. No. 5,976,336, incorporated herein by reference in its entirety), chemically sensitive field effect transistors (ChemFETs), and other valuable sensor technologies.

Next generation sequencing methods are often conducted as nano-scale assays and involve complex reaction mixtures. Examples of such next generation sequencing methods include, but are not limited to, single-molecule real-time sequencing (Pacific Biosciences), ion semiconductor sequencing (ion torrent sequencing), pyrosequencing, sequencing by synthesis (Illumina), Combinatorial probe anchor synthesis (cPAS-BGI/MGI), sequencing by ligation (SOLiD sequencing), nanopore sequencing, and chain termination (Sanger sequencing).

Proteomics assays are also conducted as nano-scale assays and may include analyses and equipment such as antibody-based detection, mass spectrometry, protein chips, and reverse-phased protein microarrays. Proteomics assays are used in applications such as drug discovery, establishment of protein interactions and networks, protein expression profiling, identification of biomarkers, proteogenomics and structural proteomics.

Any or all of the applications described above may benefit from the use of plate arrays such as the plate arrays described herein.

### V. Reservoirs with Plurality of Shelves

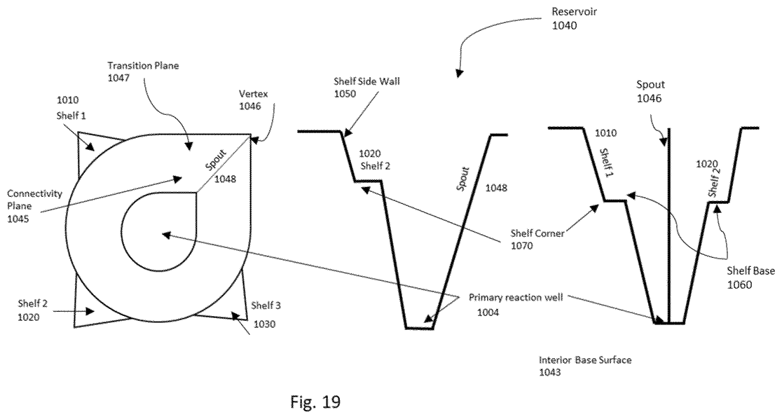

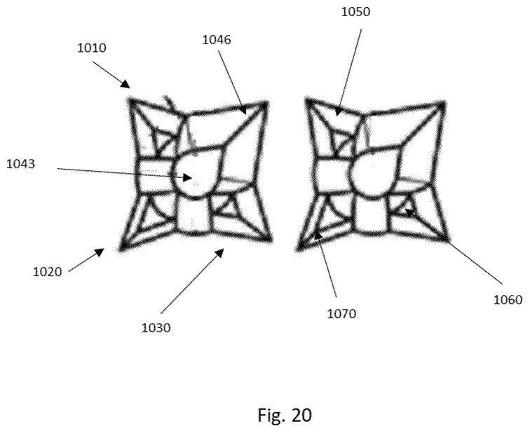

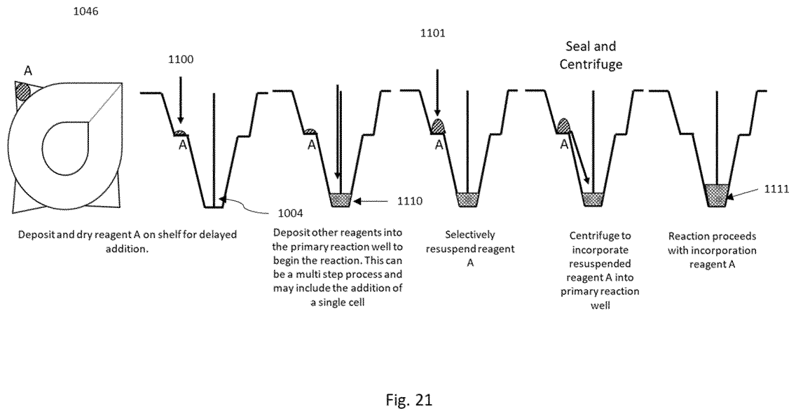

Turning to FIGS. 19 and 20, there is another embodiment of reservoir 1040. The reservoirs are nano-vessels and may be configured in plate arrays, similar to the arrays in FIGS. 2A-4B. The arrays may include four plates as shown in FIG. 2A or FIG. 24A, each having 96 reservoirs formed therein in a general configuration similar to a conventional 96-well microtiter plate (8×12 reservoirs). In FIGS. 2A to 4B, there is shown a second embodiment of a nano-vessel plate array 200 configured with four plates on an upper platform surface 211. This embodiment 200 differs from the plate array 100 described above, in having four plates which are not sloped. The upper surfaces of each plate are substantially horizontal with each of the four corners at substantially the same level. In addition, plate array 200 does not have a partially circumscribing recess as included in plate array 100.

In plate array 200, the reservoirs 240 are also teardrop shaped. In the top views of four reservoirs 240 in FIG. 2D (representing a magnified inset of FIG. 2A) and particularly in the side views of FIGS. 2E and 2F, it is seen that each of the reservoirs 240 is tapered inwards towards its teardrop-shaped base surface 243. While the side elevation views of FIGS. 2E and 2F provide the general appearance of a cone-shaped reservoir 240, the perspective view of FIG. 3 more clearly indicates that each reservoir 240 is pitcher-shaped with a frustoconical portion 249 transitioning at planes 247a,b to form a spout portion 248 terminating at vertex 246 which is aligned with connectivity plane 245. Thus, most of the upper edge 241 of the reservoir 240 is circular with a transition to a straight line to the vertex 246 at each transition plane 247a,b.

This pitcher-shaped reservoir 240 is defined by having a sidewall 242 with a slope transitioning from a steeper slope to more gradual slope at the spout portion 248 as shown in FIG. 4B, which represents a cross-sectional side view of the reservoir 240 as generated by a 90-degree rotation of the top view of reservoir 240 along axis A of FIG. 4A. FIG. 4B demonstrates that the angle α between a perpendicular reference plane P-1 intersecting the edge of the base 243 closest to the vertex 246 and the connectivity plane 245 is greater than the angle θ between a perpendicular reference plane P-2 intersecting the edge of the base 243 in the frustoconical portion 249 and the interior sidewall 242 of the frustoconical portion 249.

This pitcher-shaped reservoir 240 has been found to be an effective reservoir shape to provide improvements in processes for dispensing fluids into the reservoir 240 and removal of sample fluids contained therein.

Alternative embodiments may have fewer or more reservoirs and/or fewer or more plates. The reservoirs 1040 of this embodiment are nano-vessels, meaning that they are configured to hold nanoliter volumes. However, the features of this embodiment may also be used in plates configured to hold microliter volumes. The spout 248 is intended to be pointed in an opposite or a same direction of centrifuge rotation. This orientation utilizes the acceleration of the centrifuge to move a fluid up or down the spout, respectively.

The recess 125 provides structure for connection of a recovery funnel (not shown) or adapter 2200 having a complementary recess-coupling ridge-like structure to facilitate drainage of the contents of the reservoir 1040. An alternative embodiment described hereinbelow will be used to highlight the features of an array of recovery funnels.

The embodiment of the reservoir 1040 is shown as a tear-drop shape as shown in the top view of FIG. 19. This shape is similar to other embodiments of the reservoir 140 and 240. The embodiment 1040 has the addition of a plurality of shelves surrounding the primary reaction well 1004. The side elevation views of the reservoir 1040 suggest a general appearance of pitcher-shape with a frustoconical portion transitioning at planes 1047 to form a spout portion 1048 terminating at vertex 1046 which is aligned with connectivity plane 1045. Thus, most of the upper portion of the reservoir 1040 is circular with a transition to a straight line to the vertex 1046 at each transition plane 1047. The transitions around the primary reaction well 1004 may be either smooth and rounded or have clearly defined transitions with corners and angles. The interior base 1043 may have different perimeter shapes, including a tear drop or rounded or any other appropriate shape. The interior base may be flat, concave, or convex. Different geometries of the interior are contemplated based on intended use of the reservoir as well as known and contemplated manufacturing processes.

The embodiment of reservoir 1040 includes at least one and preferably a plurality of shelves about a central axis of the reservoir and extending from the interior side wall 1042. Although the reservoirs in FIGS. 19-23 show three shelves equally spaced about the reservoir, it is contemplated that the reservoir 1040 may have as few as one shelf or as many as may be created. The shelves may be equally spaced or randomly located around the reservoir 1040. The shelves depicted have a triangular or frustoconical shape, but it is also contemplated that the shelves have any geometry.

The top view of the reservoir 1040 in FIG. 19A depicts three shelves about the center of the reservoir 1040. The first shelf 1010 is to one side of the spout 1046. The second shelf 1020 is generally opposite from the spout 1046. The third shelf 1030 is generally between the second shelf 1020 and the spout 1046. The shelves may be located anywhere between the top of the reservoir and the interior base surface 1043; however, FIGS. 19 and 20 depict the shelves between halfway up the reservoir 1040 and around the top one-third. The plurality of shelves may be at the same distance from the interior base surface 1043 or each shelf may be located a different distance from the interior base surface 1043. Any multiple of shelves may be at different heights to allow for temporary separation of substrates and process steps, from the primary reaction well 1004.

Each shelf may be comprised of several components including a shelf base 1060 and at least one shelf side wall 1050 and a shelf corner 1070. The shelf base 1060 may be flat and parallel or non-parallel to the interior base surface 1043, depending on the properties and use of any substrate that may be placed on the shelf. The shelf base 1060 maybe tilted so that a substrate may more easily flow off the shelf into the reservoir. The shelf base 1060 may also be oriented away from the interior of the reservoir 1040, so that the substrate does not easily flow into the reservoir 1040. The shelf side wall 1050 may also comprise any geometry to affect the placement and movement of a substrate placed onto the shelf. The shelf side wall 1050 may be further comprised of two walls which create a corner at the point of contact with the shelf base 1060. The corner creates capillary action to help control the addition and recovery of a fluidic substrate into and out of the reservoir 1040 and the primary reaction well 1004. In addition to a configuration with angular connections between the shelf side walls 1050 and the shelf base 1060, the shelves may have a curved design with more gradual convergences of the shelf side walls 1050 and the shelf base 1060.

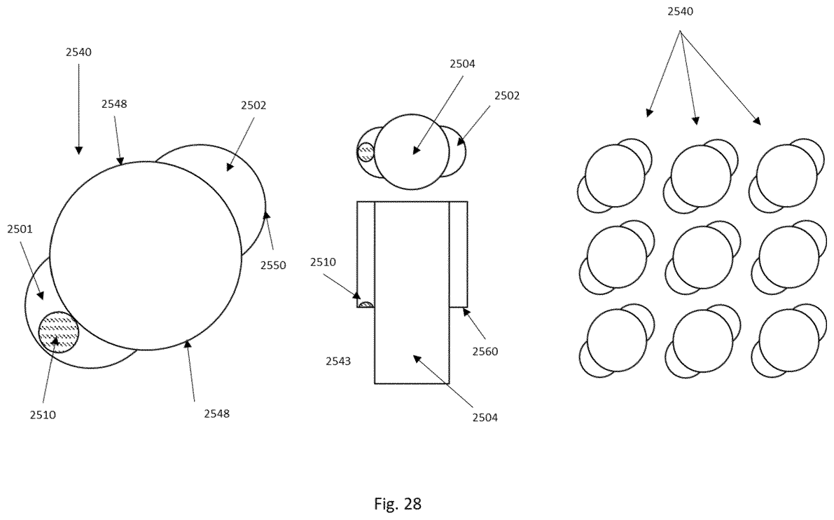

Another embodiment of a reservoir 2540 is depicted in FIG. 28. The reservoir 2540 is shown having a cylindrical shape. Because of the uniformly cylindrical shape of the reservoir 2540, it may not have a distinct spout. Therefore, the edge of the top of the reservoir may act as a spout 2548, similar to that of a common bottle with a round mouth. The reservoir may have at least one and preferably a plurality of shelves about the center of the reservoir 2540. The shelves 2501 2502 in FIG. 28 are shown with a flat shelf bottom 2560 and a curved shelf side wall 2550. A substrate 2510 is shown on the flat shelf bottom 2560 on the first shelf 2501. The plurality of shelves 2501 2502 may be at the same distance from the interior base surface 2543 or each shelf may be located a different distance from the interior base surface 2543. Any multiple of shelves may be at different heights to allow for temporary separation of substrates and process steps, from the primary reaction well 2504. The cylindrical and rounded shape of reservoir 2540 may be a result of improved manufacturing processes. It is contemplated that reservoir 2540 may be milled into a solid plate using a single router bit. It is also contemplated that reservoir 2540 may be milled using a minimal number of router bits.

### VI. Controlled Centrifugation

Turning to FIGS. 24-26, a system for directional centrifugation is shown FIG. 24A depicts a frame 2210 holding eight plates 2300 having reservoirs 1040. Other than the shape of the reservoir 1040, the plates 2300 and frame 2210 in FIG. 24A may have similar arrangements and structures shown in FIGS. 1, 2 and 9 and discussed in related sections. In preparation of directional centrifugation, the frame 2210 may be placed in an adapter 2200, shown in FIG. 24B. In order to receive and secure the frame 2210, the adapter 2200 includes elements such as an adapter floor 2206 and a frame stop 2201. In an embodiment, the frame stop 2201 may be separate corner sections positioned around the adapter floor 2206. The frame stop 2201 allows for two orientations for the frame 2210 within the frame stop 2201. The plates 2300 in the array may fit in any of four orientations when facing upward (reservoir 240 open upwards) in the centrifuge adapter 2200 and only in one position (aligned with the funnels 361) when facing downwards. In this latter position, the centrifugation of the plates 2300 forces the volume out of the nanovessel and into the collection funnels 2360.

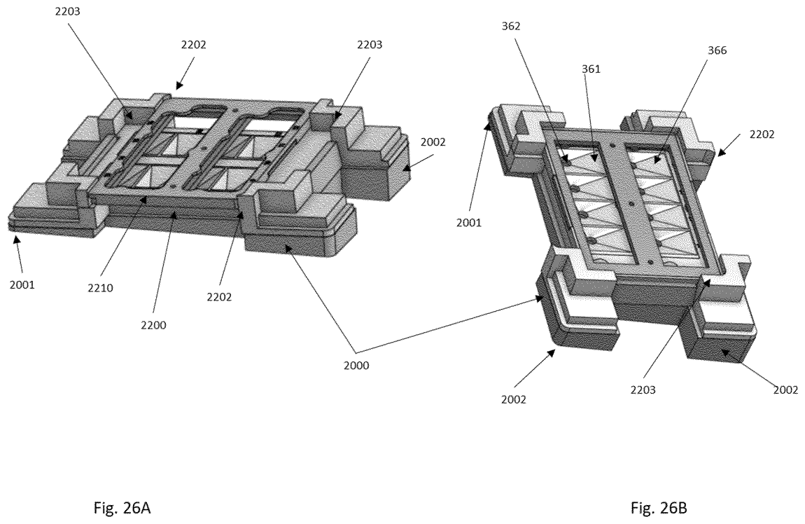

As shown in FIG. 26A, the frame 2210 may be oriented in a transverse position within the frame stop 2201 or in a longitudinal position as in FIG. 26B. In a transverse position, the frame 2210 is secured in place by a transverse frame stop 2202, which may be a small tab or extension that engages a portion of the frame 2210. The transverse frame stop 2202 is shown on opposing corner sections of the frame stop 2201, which not only prevents the frame 2210 from slide off of the adapter 2200, the transverse frame stop 2202 also prevents the frame 2210 from rotating within the frame stop 2201. It is contemplated that the transverse frame stop 2202 may include extensions on all of the corner sections. The transverse frame stop 2202 may include other structural elements that secure the frame 2210 in a transverse orientation on the adapter 2200.

As shown in FIG. 26B, the frame 2210 may be oriented in a longitudinal position within the frame stop 2201. In a longitudinal position, the frame 2210 is secured in place by a longitudinal frame stop 2203, which may be separate corner sections of the frame stop 2201. The longitudinal frame stop 2203 may be internal corners of the separate corner sections, which engage outside corners of the frame 2210. The engagement between the frame 2210 and the longitudinal frame stop 2203 prevent lateral or rotational movement of the frame 2210 when secured onto the adapter floor 2206 of the adapter 2200. The longitudinal frame stop 2203 may include other structural elements that secure the frame 2210 in a longitudinal orientation on the adapter 2200.

The adapter 2200, as shown in FIGS. 24A and 24B includes a funnel array 2360. The funnel array 2360 may be a separate unit having any number of generally rectangular funnels 361, which may be placed in the adapter 2200 such that each funnel 361 extends below an upper surface of the adapter 2200. Each funnel 361 has a sump 366 formed of sloped surfaces extending downwards from each side of the funnel 361 leading to a drain outlet 362. A collection vessel may attach to the drain outlet 362 during centrifugation. The sumps may take any design or include any number of sides that generally direct toward to the drain outlet 362. The sump 366 may include smooth surfaces or a plurality of sides. In an embodiment, each sump is positioned below a plate 2300 in a frame 2210. The funnel array 2360 may be utilized in a pooling or collection step, whereby a volume of liquid or substance too small to be removed from the nanovessel, may be collected via centrifugation. The funnel array 2360 may be placed in the adapter with the plate array 2300 directly above, so that the reservoirs 1040 in each plate face into the funnel 361. The force of centrifugation causes the substance in the reservoir 1040 to collect in the respective funnel 361 in the funnel array 2360. It is contemplated that when a funnel 361 or a funnel array 2360 is secured onto the adapter 2200, plates 2300 could be secured to individual funnels 361 or a funnel array 2360 without the use of a frame 2210. Various embodiments are contemplated to secure the plates 2300 to the funnels 361, 2360, such as clips, complementary notches, friction fits, or any other known releasable connection means.

If an assay was performed in the reservoirs 1040 of two adjacent plates 2300 with a first cell type in a first plate and a second cell type in a second plate, the pooled samples collected by the separate funnels 361 would provide two distinct pooled samples each containing a specific cell type. An example of this assay is that the same 96 molecular identifiers are first in each plate 2300, then pooled, and then tagged by another identifier in subsequent steps. With the two layers of identification, all individual wells can be identified. In this embodiment, if sample fluid moving from a reservoir 1040 to its respective funnel is incidentally induced to flow outwards via capillary action between an upper body surface of the plate array 2300 and the surface of dividers, of the funnel array 2360, the capillary flow will be halted by the wider area at the sumps 366. This prevents cross-contamination between the funnels 361.

As shown in FIG. 9, collecting vessels 370a-d may be connected to the outlets 361 of the funnel array 2360. This assembly is placed in a separate housing (not shown) designed to rigidly retain the assembly within a centrifuge such that during centrifugation, with the plate array 2300 placed upside down, fluids contained within each reservoir 1040 are induced to flow out of the reservoir 1040 via the spout 1048, through the respective funnels 361 and outlets 362 and into the collecting vessels 370. It is to be understood that all wells of each plate 2300 will be pooled together into respective collecting vessels 370. Therefore, it is possible to conduct an experiment with as many separate conditions or sample components as in the separate plates.

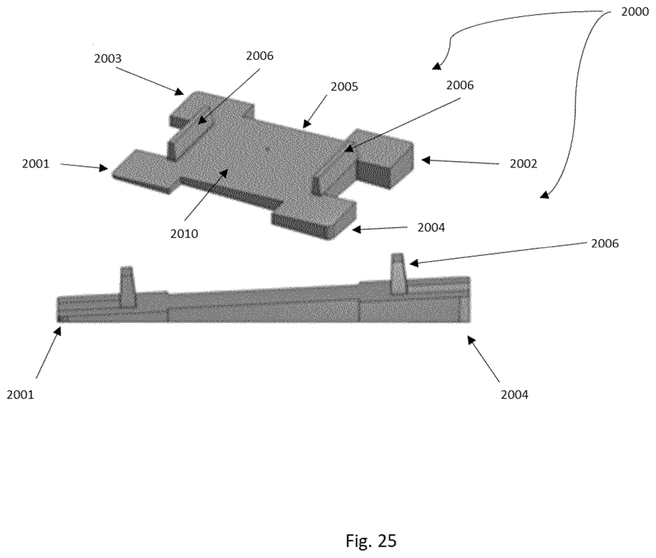

Turning to FIG. 25, a centrifuge adapter angle block 2000, also referred to as a wedge, is shown. The wedge 2000 allows for directed centrifugation of specific shelves 1010 1020 1030 during centrifugation. The wedge 2000 has four different corners, each having different thicknesses. The thinnest corner 2001 is generally opposed to the thickest corner 2002. Corner 3 2003 and corner 4 2004 have generally similar thicknesses, although for stability, either corner 3 2003 or corner 4 2004 may be slightly thicker than the other. The wedge 2000 has an upper surface 2010 onto which the adapter 2200 may fit. In an embodiment shown in FIG. 25, the wedge 2000 has a plurality of notches 2005 and tabs 2006 configured to allow for fitment of the adapter 2200. As shown in FIG. 26B, the adapter frame stops 2201 may rest between the tabs 2006. Laterally, the wedge 2000 and adapter 2200 may have open sides, which provides an ease of handling and reduction of total mass, allows for a transverse orientation of the frame 2210, as in FIG. 26A. In operation, the wedge allows for a user to choose from which shelf 1010 1020 1030 a reagent should be utilized. For example, in an embodiment of the nanovessel having three shelves, the shelf that is opposed to the thinnest corner 2001 of the wedge 2000, will experience the centrifugal force acting on a reagent, pulling the reagent into the reservoir 1040. At the same time, a reagent on the shelf closest to the thinnest corner 2001, will have a force directing the reagent away from the reservoir 1040 toward the shelf side wall 1050 into the shelf corner 1070 and not toward or into the reservoir 1040. A reagent on a shelf aligned with the other two corners 2003 and 2004, will also be directed toward a shelf side wall 1050 and the shelf corner 1070 and not into the reservoir. The user can rotate an individual plate 2300, the frame 2210 or the adapter 2200 about the wedge 2000 to select the reagent on a shelf 1010 1020 1030 to be centrifuged into the reservoir 1040. The user may then rotate an individual plate 2300, the frame 2210 or the adapter 2200 about the wedge 2000 to select a different shelf for selective centrifugation.

Turning now to FIGS. 21-23, examples of assays that utilize an embodiment of the invention having shelves 1010 1020 1030. FIG. 21 shows the steps for a simple delayed addition of a reagent. Reagent A 1100 is deposited and dried on a shelf 1010, for delayed addition in an assay. The dried reagent is stable and secure to the shelf 1010. Additional reagents 1110 may be deposited onto the spout 248, into the reservoir 1040, or into the primary reaction well 1004. Alternatively, subsequent reagents may be added to any of multiple different locations, or staging areas, in the nanovessel. The staging areas may include any of the plurality of shelves (1010, 1020, 1030, or more), the spout 248, or into the reservoir 1040. This may be a multistep process and may include the addition of a single cell. This begins the reaction. Next reagent A 1100 may be resuspended in a liquid state, by the deposition of an aqueous solution or other solvent onto the dried reagent 1100. After resuspension of the reagent 1100, the nanovessel may be sealed and centrifuged. The centrifugation forces the resuspended reagent 1100 off of the shelf 1010 and into the primary reaction well 1004 where the reaction proceeds. Although not shown, it is contemplated that additional reagents may be dried and resuspended on additional shelves 1020 1030 either simultaneously or subsequent to the activity for reagent A 1100.

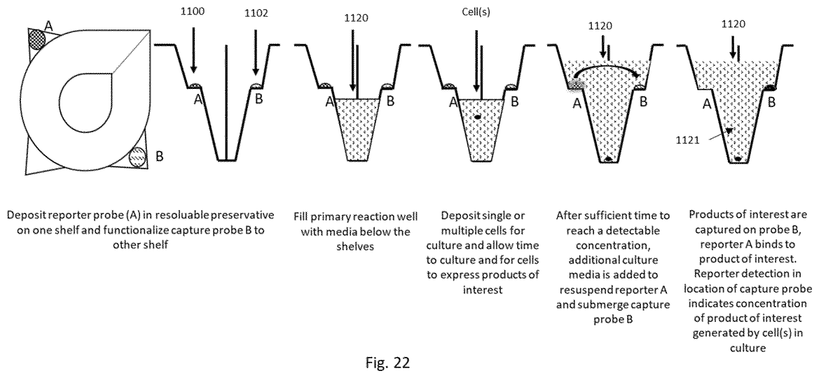

FIG. 22 depicts the steps for an in-well assay using an embodiment of the invention having multiple shelves. This assay utilizes reporter probes to capture products of interest. On a first shelf 1010, a first reagent 1100 is deposited in a resoluble preservative. On another shelf 1020, a second reagent 1102 is deposited and immobilized. The first reagent 1100 may be a reporter probe and the second reagent 1102 may be a capture probe. Next, the primary reaction well 1004 is filled with media 1120 to a level below the shelf base 1060. A single cell or multiple cells may be deposited into the media 1120. The deposited cell(s) are allowed enough time to culture and express products of interest. After sufficient time to reach a detectable concentration of products of interest, additional media 1120 is added to the reaction well 1040 to cover the first shelf 1010 and the second shelf 1020. The first reagent reporter 1100 is resuspended and the second reagent, capture probe, 1102 is submerged. Products of interested are captured on capture probe 1102 and reporter 1100 binds to the product of interest. Alternatively, the shelves may be at different heights or distances from the interior base surface 1043. Using this embodiment of the nanovessel, wherein the first shelf 1010 is further from the base 1043, than the second shelf 1020, the second shelf 1020 may be covered first allowing incubation with the second reagent. After a time, additional media or reagent is added to bring the total volume up above and submerging the first shelf 1010. Similarly, a three-step process could occur with sequential additions each submerging a different shelf, respectively. The reporter 1100 detection in the location of capture probe 1102 indicates the concentration of the product of interest generated by the cell(s) in culture 1120.

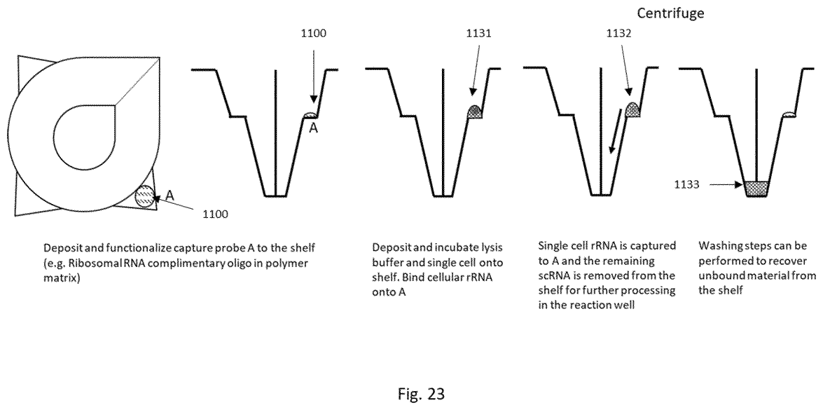

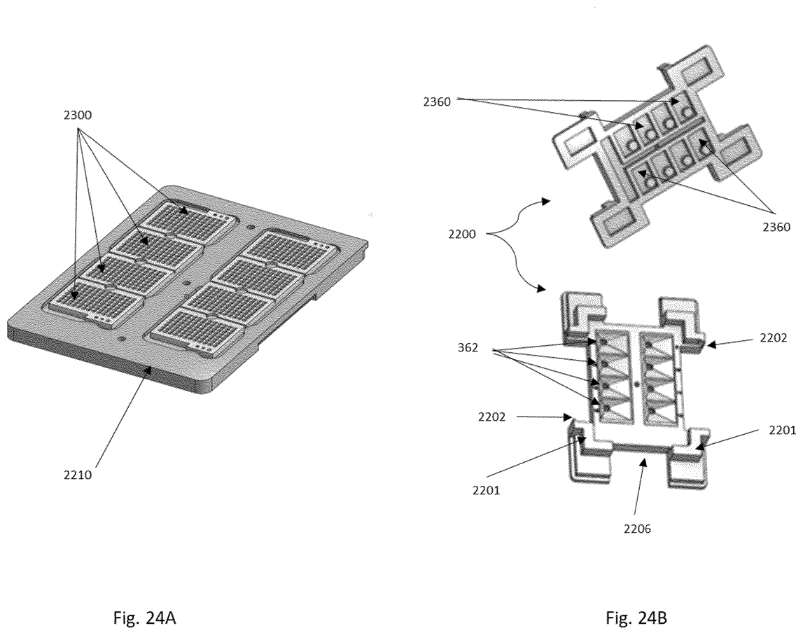

FIG. 23 depicts the steps for an in-well single cell clean up assay. A capture probe 1100 is deposited and immobilized on a first shelf 1020. The probe 1100 remains functional. The probe 1100 may be ribosomal RNA complimentary oligos in a polymer matrix. A combination 1131 of a single cell and lysis buffer may be deposited onto the probe 1100 and incubated. This reaction allows cellular rRNA to bind onto the probe 1100. Single cell rRNA 1132 is captured onto probe 1100 and the remaining single cell RNA 1133 (scRNA) may be centrifuged and removed from the shelf 1020 for further processing in the primary reaction well 1004. Additional washing steps may be performed to recover any unbound material from the shelf 1020.

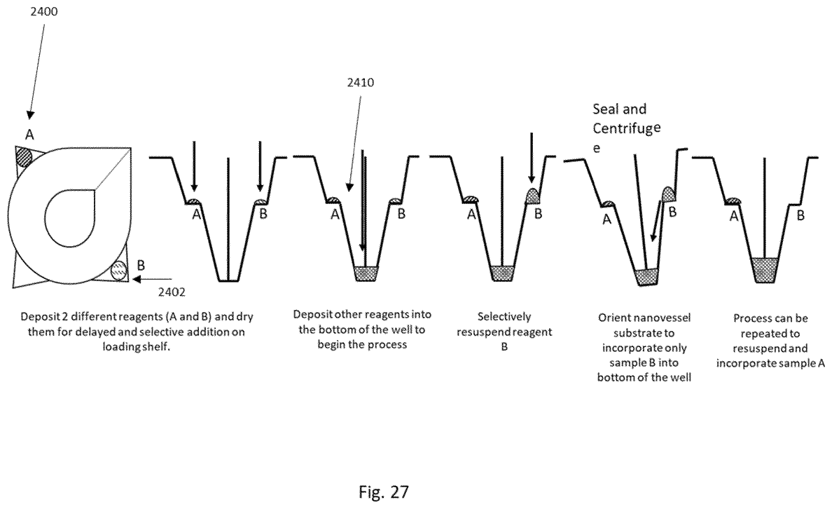

Turning now to FIG. 27, an example of an assay using an embodiment of the invention having multiple shelves around the reservoir 1040 and performing selective centrifugation is depicted. A first reagent 2400 is deposited and dried onto a first shelf 1010. A second reagent 2402 is deposited and dried onto a second shelf 1020. Both reagents 2400 2402 are dried onto the respective shelves. Additional reagents 2410 may be deposited into the primary reaction well 1004 to begin the process. The second reagent 2402 is selectively resuspended on the second shelf 1020. The nanovessel is oriented so that only the second reagent 2402 is centrifuged into the primary reaction well 1004. The orientation is attained by using the wedge 2000 and/or a combination of the adapter 2200 holding the frame 2210 in a specific orientation, so that the second shelf 1020 is furthest away from the thin corner of the wedge. During centrifugation, the force will pull the second reagent 2402 into the reservoir 1040 and the other reagents 2410. During the same centrifugation step, the force will push the first reagent toward the shelf sidewall 1042 or the shelf corner 1070, thus preventing the first reagent 2400 from entering the reservoir. The steps may be repeated for the first reagent 2400 on the first shelf 1010. Alternatively, three reagents may be used, each of which is separately resuspended and centrifuged. Selective centrifugation may be utilized with any of the preceding assays or other assays that would benefit from selective introduction of different reagents into the reservoir 1040 and different steps.

Further considerations and uses of the invention include adaptation to handle magnetic particles inside the nanovessels. Additionally, it is contemplated to pre-load the reservoirs with an oil or droplet cloaking lubricant. The lubricant is a multilayer fluid that decreases evaporation.

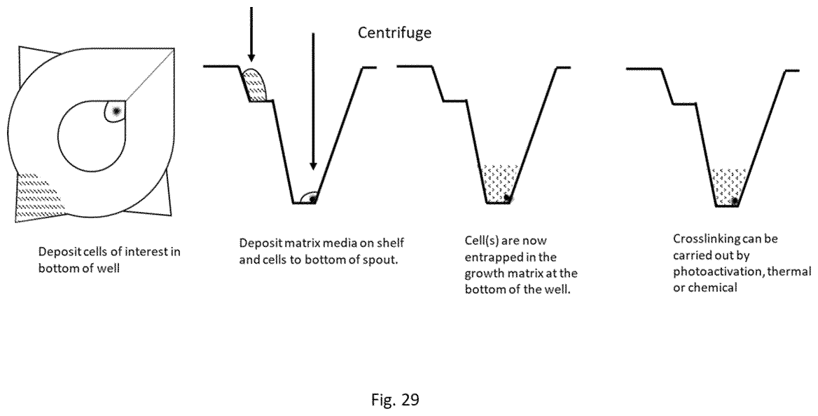

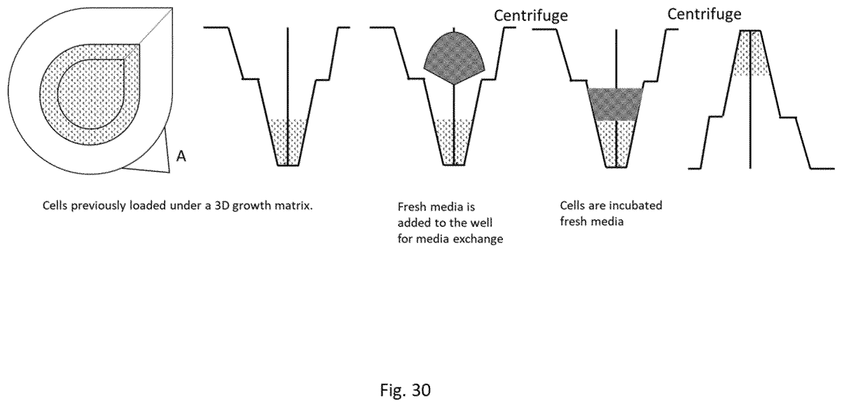

Turning now to FIGS. 29 and 30, an embodiment of an assay for cell entrapment or encapsulation is depicted. In FIG. 29, using a nanovessel with or without shelves as described above, a cell or cells are deposited in the primary reaction well 1004 of the reservoir 40. A matrix media may then be deposited on the spout 1048 any of the plurality of shelves surrounding the reservoir 1040. After centrifugation, the matrix media is forced into the reservoir and onto the cell(s). The cell(s) are entrapped in the media at the bottom of the reservoir 40. Crosslinking can then be performed by reasonable means, such as photoactivation, thermal or chemical activation. FIG. 30 depicts a method for exchanging the media in a nanovessel, in which a cell(s) have already been loaded in a 3D growth matrix. To the reservoir 1040, fresh growth media may be added before a first round of centrifugation. Centrifugation will force the fresh media on top of the matrix allowing the existing cells to incubate in the new media. Excess or waste media, still liquid, may be removed from the nanovessel via an inverted centrifugation, as discussed above. The excess media may be collected in a funnel for further analysis.

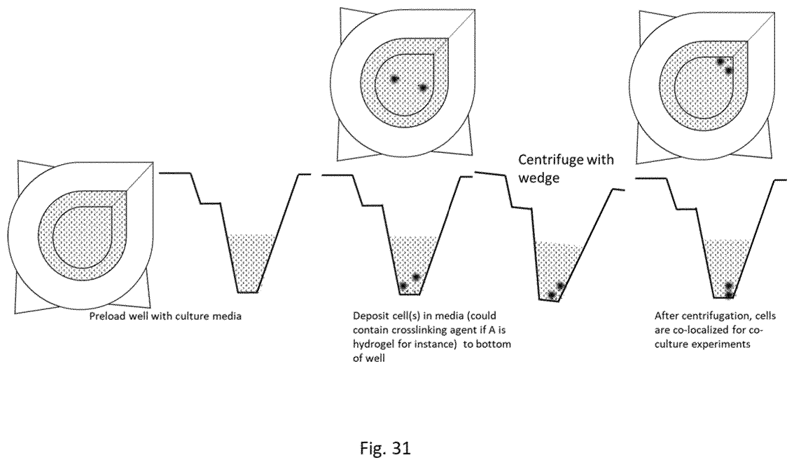

Turning to FIG. 31, the embodiment of the nanovessel with or without a plurality of shelves may be used for the colocalization of cells within the reservoir 1040. The primary reaction well 1004 may be preloaded with media, then at least two cells may be deposited into the media in the primary reaction well 1004. The nanovessel is then loaded onto the centrifuge wedge 2000, so that a user can elect which area of the primary reaction well 1040 the cells will be localized. Referring to FIGS. 25 and 26, depending on how the nanovessel and plate 2300 and frame 2210 is loaded onto the adapter 2200 and the wedge 2000, cells will be force to a specific area on the interior base surface 1043, specifically the area lined up with corner 2001. This method is useful for co-culture experiments that require cells to be close together or colocalized.

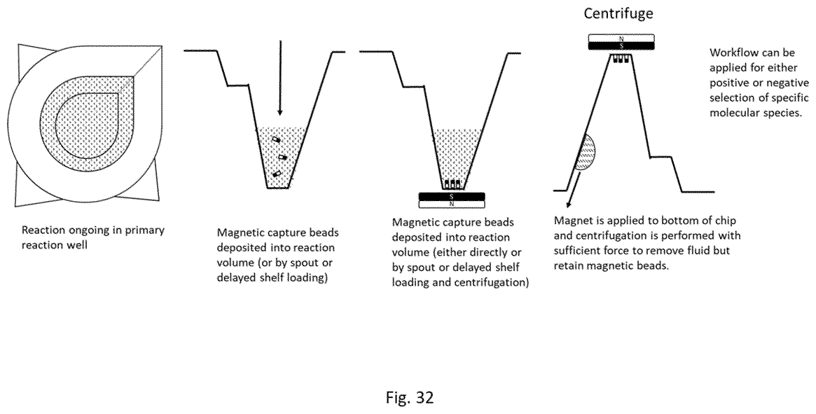

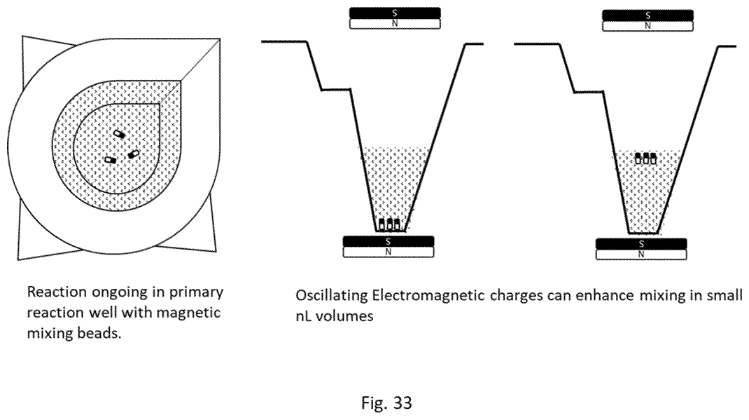

The embodiment may be used in conjunction with magnetic capture beads, as depicted in FIGS. 32 and 33. FIG. 32 depicts an assay used for negative or positive capture of a product using magnetic capture beads in the nanovessels. A contemporaneous reaction may occur in the primary reaction well 1040 then magnetic capture beads may be deposited into the well 1040. Magnetic beads are usually bound to antibodies or other molecular binding substrates. The beads bind and capture specific elements within the media. The magnetic beads are then localized by a magnet to a specific place within the reservoir 1040; the interior base surface 1043 is shown. With the magnet secured adjacent the interior base surface 1043, the nanovessel may then be centrifuged upside down to collect excess media. The magnetic capture beads may then be collected and rinsed to release the bound substrate. Alternatively, the magnetic capture beads may be used to capture an unwanted waste product from the reaction, so that the pooled and collected media contains desirable products. So, the magnetic capture beads may be rinsed in the nanovessel by dispensing rinse and release agent into the reservoir and incubating. The liquid is recovered by repeating the magnetic retention of the beads during centrifugation. The magnetic beads may also be recovered, and the bound material can be released in bulk. FIG. 33 depicts a method of using magnetic mixing beads to agitate or mix a reaction in a nanovessel. Magnets above and below the nanovessel may act upon deposited magnetic mixing beads by oscillating electromagnetic charges, which cause the beads to move within the media.

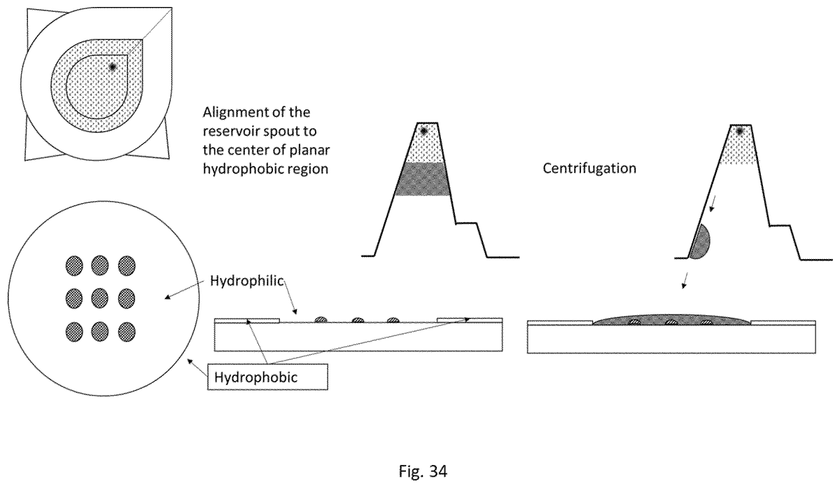

The embodiment may also be used to transfer cell product media or a reaction product to a planar array, as depicted in FIG. 34. Instead of centrifuging into a funnel 361 for pooling and collection, fluid in the nanovessel may be centrifuged onto a planar array of hydrophilic regions. The spout 1048 is aligned with the center of a hydrophilic array, so that centrifugation forces the liquid down the spout 1048 in a controlled direction. The fluid is forced from the spout 1048 onto the array which may have been pre-spotted with an array of capture probes, which allows for a multi-analyte readout, such as ELISA sandwich assay. Because the spout 1048 of the nanovessel allows for a specific directionality of the expelled liquid, individual wells 1004 can be analyzed.

All of the aforementioned assays and methods may be performed with a single cell or multiple cells or fluids containing other substances of interests depending on the intended result of the assays. Substances of interests may include viruses, exosomes, chemical, or other biological materials. Nothing stated above is intended to limit the steps, reagents, or product used in or as a result of the nanovessel and plate embodiments.

### VII. Kits

Certain aspects of the invention include provision of kits for conducting nano-scale assays. Various embodiments of such kits include a plate array including a plurality of plates supported on a platform, such as the plate arrays 100, 200, 300, 400, or 2300 described herein or other plates having reservoirs with at least some of the reservoir features described herein. In some embodiments, the plate array includes a molecular identifier contained within each reservoir of each plate of the plate array. In some embodiments, the kit also includes a recovery funnel array with a funnel for each plate. In some embodiments, the funnels are provided as a connected array with a matched funnel for each plate of the plate array to facilitate a process for generating a pooled sample from individual samples contained within individual reservoirs on a plate of the plate array. In some embodiments, the kit includes collection vessels configured to be coupled to the funnel outlets for collection and retention of a pooled sample. In some embodiments, there is provided a kit with a plate array, a funnel array with a series of connected funnels matched to each plate of the plate array, collection vessels and a series of reagents for performing an assay. Some kit embodiments further include a plate array housing configured for connection to a centrifuge to promote sample collection. Other kit embodiments further include a plate array holder configured to be connected to a specific dispensing device. Example embodiments of kits include, but are not limited to, kits for performing single cell RNA sequencing, single cell whole genome amplification, and single cell proteomics by mass spectrometry.

### Example 1

I. High Quality and Sensitivity 3′ scRNA-Seq Library Preparation in cellenCHIP™

Single-cell RNA sequencing (scRNA-seq) assays must combine both sensitivity and accuracy to capture and reverse-transcribe diverse transcripts in their relative proportions from a single cell. In this study, it was shown that combining the cellenONE® for single cell isolation and nanoliter dispensing with the cellenCHIP™ as a microwell substrate for library preparation provided an ideal platform for cost efficient and high sensitivity transcriptomic analyses from single cells.

### Materials and Methods

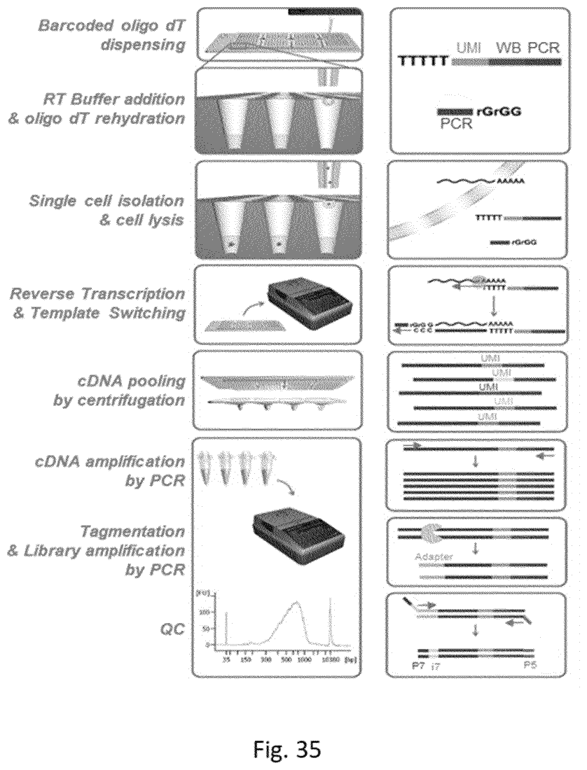

The cellenCHIP™ labware is comprised of 4×96 well arrays that are each barcoded with 96 unique oligo dTs using cellenONE® and air-dried overnight. Each well contained a unique oligo dT primer with an individual Well Barcode (WB) and Unique Molecular Identifier to respectively trace back sequencing reads to each corresponding well and quantify the number of reads for each transcript. Wells were filled with Lysis and Reverse Transcription (RT) Buffer containing Template-Switch Oligos (100 nl/well). Single human and mouse cells (HEK and NIH3T3) were then isolated into the prefilled wells. Wells were sealed (Microseal ‘F’ and ‘B’, Bio-Rad, USA) and RT and Template Switching incubation was performed on an in situ block inside a GS1 thermocycler (G-storm, UK) at 42° C. for 90 min. After unsealing, the cellenCHIP™ was inverted and barcoded cDNAs from 96 single cells were pooled by centrifugation into a recovery funnel prior to transfer to microcentrifuge tubes. cDNAs were amplified for a maximum of 18 PCR cycles, and amplified cDNAs were used to generate Illumina sequencing libraries with one-sided tagmentation and PCR amplification. The libraries went through quality control for size distributions and sequenced using an Illumina sequencer. FIG. 35 shows the workflow diagram for the analysis kit.

### Results

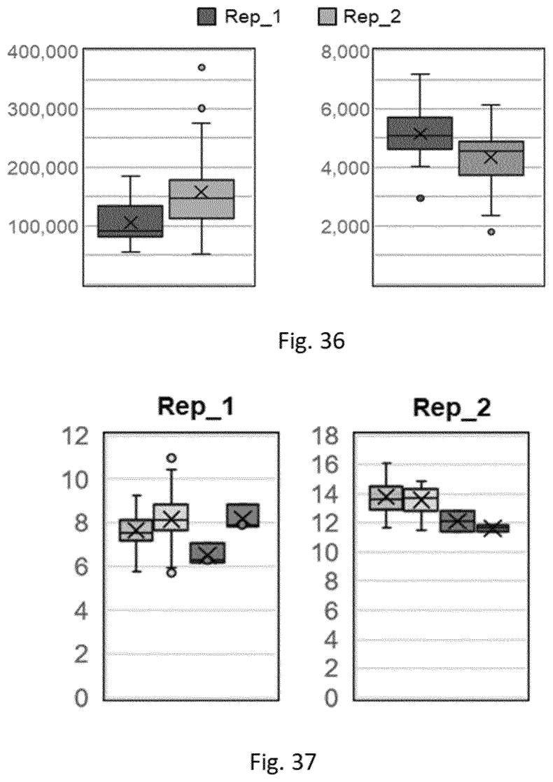

To investigate the sensitivity and reproducibility of the protocol, two independent biological replicates (Rep_1 and Rep_2) were prepared using checkerboard patterns of single human and mouse cells. Sequencing reads were demultiplexed and mapped back to each isolated single cell thanks to known Well Barcode (WB). The total mapped reads per cell in each replicate were on average 100,000 and 150,000, with mapped reads from individual cell ranging from 50,000 to 200,000 for the first replicate and 50,000 to 350,000 for the second replicate (FIG. 36). This variability seems to be due to the cell heterogeneity, which induces different quantities of cDNA generated from each cell. These mapped reads were then used to identify expressed genes in each cell (genes with at least 1 UMI). On average, the 3′ cellenRNA-seq kit allowed to achieve a coverage of 4,500 to 5,000 genes per single cell, and can detect up to more than 7,000 genes (FIG. 336), which underlies the high sensitivity of the 3′ cellenRNA-seq kit for gene detection. We can also observe a high reproducibility between the two biological replicates.

The presence of UMIs in the oligo dT primers is crucial to eliminate the effects of PCR amplification bias, which is particularly important in single cell studies where many PCR cycles are required for whole transcriptome amplification. After PCR, molecules sharing a UMI are assumed to be derived from the same input molecule. To examine the quality of the 3′ cellenRNA-seq kit, we calculated the number of mapped reads per UMI for the single cells and the positive controls that correspond to wells where 5 human or mouse cells were dispensed. We observed a high reproducibility between the samples, where there are on average 7 mapped reads per UMI for the first replicate and 13 for the second (FIG. 37). Altogether these data show that the 3′ cellenRNA-seq kit has a high reproducibility.

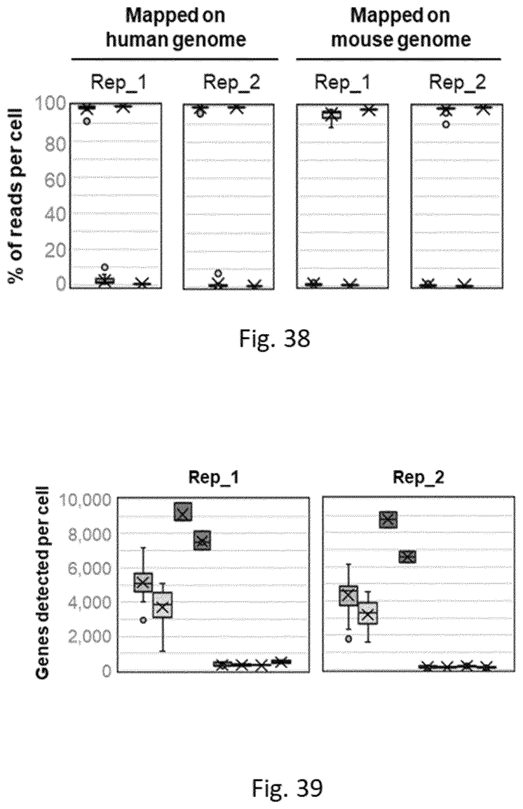

To further investigate the quality and the sensitivity of the 3′ cellenRNA-seq kit by using the nanoliter cellenCHIP™ support and the cellenONE® technology, we performed the experiment by dispensing two different types of cell, human and mouse cells, in a checkerboard manner. We analyzed the percentage of reads per cell that mapped on the human and mouse genomes for each well in order to determine if there are any contaminations between wells. We observed that for the majority of the cells nearly all+of the reads per cell only mapped to human genome for the wells where human cells where dispensed (FIG. 38). These observations indicate that there is no cross contamination between cellenCHIP™ wells by using the 3′ cellenRNA-seq kit with the cellenONE® technology.

Next, we compared the number of genes detected per cell between the single cell conditions and the positive controls (5 dispensed cells), and negative controls. Four different negative controls were tested, (i) dispensing of a human single cell and RT buffer without RTase, (ii) no cell dispensing, (iii) dispensing of medium culture without any cell, and (iv) dispensing of a human single cell with RT buffer that contains RNAse. We observed that more genes have been detected for the positive controls compared to the single cells (FIG. 39), highlighting that more cDNA were produced in the wells containing multiple cells. As assumed, only very few genes are detected for all the four negative controls (FIG. 39), confirming that there is no contamination between the cellenCHIP™ wells.

Altogether these observations highlighted the proper quality and the high sensitivity of the 3′ cellenRNA-seq kit.

The use of the 3′ cellenRNA-seq kit in combination with the cellenONE® technology and the cellenCHIP™ support allows users to perform whole transcription amplification in nanoliter volume with little to no well contaminations with a system that provides high sensitivity and low background.

### VIII. Definitions

Unless stated otherwise, the following terms and phrases have the meanings described below. The definitions are not meant to be limiting in nature and serve to provide a clearer understanding of certain aspects of the present disclosure.

About: As used herein, the term “about” means+/−10% of the recited value.

Approximately: As used herein, the term “approximately” or “about,” as applied to one or more values of interest, refers to a value that is similar to a stated reference value. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Feature: As used herein, a “feature” refers to a characteristic, a property, or a distinctive element.

Sample: As used herein, the term “sample” or “biological sample” refers to a subset of its tissues, cells or component parts (e.g. body fluids, including but not limited to blood, mucus, lymphatic fluid, synovial fluid, cerebrospinal fluid, saliva, amniotic fluid, amniotic cord blood, urine, vaginal fluid and semen). A sample further may include a homogenate, lysate or extract prepared from a whole organism or a subset of its tissues, cells or component parts, or a fraction or portion thereof, including but not limited to, for example, plasma, serum, spinal fluid, lymph fluid, the external sections of the skin, respiratory, intestinal, and genitourinary tracts, tears, saliva, milk, blood cells, tumors, organs. A sample further refers to a medium, such as a nutrient broth or gel, which may contain cellular components, such as proteins or nucleic acid molecule.

Substantially: As used herein, the term “substantially” refers to the qualitative condition of exhibiting total or near-total extent or degree of a characteristic or property of interest. One of ordinary skill in the biological arts will understand that biological and chemical phenomena rarely, if ever, go to completion and/or proceed to completeness or achieve or avoid an absolute result. The term “substantially” is therefore used herein to capture the potential lack of completeness inherent in many biological and chemical phenomena.

Substantially equal: As used herein as it relates to time differences between doses, the term means plus/minus 2%.

Substantially simultaneously: As used herein means within about 0.5 to about 2 seconds.

Tapered: As used herein, means becoming diminished in thickness or width toward one end.

Ledge or shelf: As used herein, means a surface being closer to horizontal than adjacent surfaces.

Frustoconical: As used herein, means a truncated conical shape.

Frustrum: As used herein, means a circular shape formed by the plane cutting off the vertex to generate a frustoconical shape.

Array: As used herein, means an ordered series or arrangement.

Reservoir: As used herein, means a cavity designed for retention of fluids.

Assay: As used herein, means an experimental test.

Spout: As used herein, means an extension configured to induce or control flow of fluids into or out of a reservoir.

Plane: As used herein, means a flat surface. Any two points on a plane would be connected by a straight line.

Plane of connectivity: As used herein means a plane where two geometric shapes connect to each other.

Transition plane: As used herein, means a plane passing through a surface where the surface transitions from one shape to another shape.

Vertex: As used herein, means the angular point of a geometric shape.

### IX. Equivalents and Scope

Those skilled in the art will recognize or be able to ascertain using no more than routine experimentation, many equivalents to the specific embodiments in accordance with the disclosure herein. The scope of the present disclosure is not intended to be limited to the above Description, but rather is as set forth in the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The disclosure includes embodiments in which exactly one member of the group is present in, employed in, or otherwise relevant to a given product or process. The disclosure includes embodiments in which more than one, or the entire group members are present in, employed in, or otherwise relevant to a given product or process.

It is also noted that the term “comprising” is intended to be open and permits but does not require the inclusion of additional elements or steps. When the term “comprising” is used herein, the term “consisting of” is thus also encompassed and disclosed.

Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise.

In addition, it is to be understood that any particular embodiment of the present disclosure that falls within the prior art may be explicitly excluded from any one or more of the claims. Since such embodiments are deemed to be known to one of ordinary skill in the art, they may be excluded even if the exclusion is not set forth explicitly herein. Any particular embodiment of the compositions of the disclosure (e.g., any antibiotic, therapeutic or active ingredient; any method of production; any method of use; etc.) can be excluded from any one or more claims, for any reason, whether or not related to the existence of prior art.

It is to be understood that the words which have been used are words of description rather than limitation, and that changes may be made within the purview of the appended claims without departing from the true scope and spirit of the disclosure in its broader aspects.

While the present disclosure has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the disclosure.

All publications, patent applications, patents, and other references mentioned herein are incorporated by reference in their entirety. In case of conflict, the present specification, including definitions, will control. In addition, section headings, the materials, methods, and examples are illustrative only and not intended to be limiting.

1. An assay plate comprising: a body having a plurality of reservoirs formed therein, the reservoirs shaped and aligned in the body in an orientation to induce or control movement of fluids contained therein in a desired direction.

2. The assay plate of claim 1, wherein the desired direction is towards a single plane or a single point.

3. The assay plate of claim 2, wherein the reservoirs each have a spout portion, the spout portion having a vertex directed toward the single plane or the single point.

4. The assay plate of claim 3, wherein the reservoirs have a downwardly tapered frustoconical portion adjacent to the spout portion, the frustoconical portion having a frustrum forming the base of the reservoir.

5. The assay plate of claim 4, wherein the reservoirs comprise a boundary between the frustoconical portion and the spout portion defined by a pair of opposed transition planes each intersecting an inner sidewall of the reservoir at distances equidistant from the vertex such that a connectivity plane located between the vertex and the center of the base divides the spout into symmetric halves.

6. The assay plate of claim 5, wherein a first angle between a first perpendicular reference plane intersecting the edge of the base closest to the vertex and the connectivity plane is greater than a second angle between a second perpendicular reference plane intersecting the edge of the base in the frustoconical portion and an interior sidewall of the frustoconical portion.

7. The assay plate of claim 4, wherein the reservoir has a teardrop-shaped upper edge and the base is circular or teardrop shaped.

8. The assay plate of claim 6, wherein the spout includes a ledge portion, wherein a third angle between the first perpendicular reference plane and the connectivity plane on the ledge portion is greater than the first angle.

9. The assay plate of claim 1, wherein the body is rectangular and slopes downward from a single elevated corner, wherein the desired direction of the drainage of fluids is towards a corner opposite the elevated corner.

10. The assay plate of claim 1, wherein the body is rectangular with a level upper surface.

11. The assay plate of claim 1, wherein the plurality of reservoirs is 96 reservoirs.

12. The assay plate of claim 1, wherein the reservoirs have volumes of less than about 500 nanoliters.

13. A plate array comprising a plurality of assay plates according to claim 1.

14. The plate array of claim 13 wherein the plurality of assay plates is four plates.

15. An assembly comprising a rectangular plate array according to claim 13, and a rectangular funnel array comprising a plurality of rectangular funnels, each configured for connection to a single plate of the plurality of plates.

16. The assembly of claim 15, wherein each of the rectangular funnels has a collecting vessel located closer to one corner of the rectangular funnels and wherein, when the funnel array is connected to the plate array, the desired direction of drainage of fluids from each plate of the plurality of rectangular plates is towards the collecting vessel of a connected funnel of the plurality of rectangular funnels.

17. The assembly of claim 16, wherein the corners of the plate array are shaped to accept the corners of the funnel array in only a single orientation, thereby ensuring that the desired direction of drainage of fluids is towards the collecting vessel.

18. The assembly of claim 15, wherein a transverse channel is provided between adjacent plates of the plate array.

19. The assembly of claim 15, further comprising a housing for coupling the assembly to a rotor of a centrifuge.

20. A kit for conducting an assay, the kit comprising: a plate array as recited in claim 14, a rectangular funnel array comprising a plurality of rectangular funnels, each configured for connection to a single plate of the plurality of plates, and instructions for connecting the funnel array to the plate array for draining fluids from the reservoirs of the plate array via centrifugation.

21. The kit of claim 20, further comprising a housing for retaining the plate array and funnel array in a connected arrangement in a centrifuge.

22. The kit of claim 20, wherein the collecting vessels are attached to or formed integrally with the funnels of the funnel array.

23. The kit of claim 20, further comprising a frame configured to hold the plate array during dispensing of components into the reservoirs during preparation of the assay

24. The kit of claim 20, wherein each one of the reservoirs includes an identifier for identifying each one of the reservoirs during the assay.

25. The kit of claim 24, wherein the identifier is a nucleic acid molecule or a heavy metal with an isotope identifiable by mass spectrometry.

26. The kit of claim 20, further comprising reagents for the assay provided in individual vessels.

27. The kit of claim 20, wherein the assay is a sequencing assay, a gene expression assay or a protein expression assay.

28. An assay plate comprising: a body having a plurality of reservoirs formed therein, the reservoirs shaped and aligned in the body in an orientation to induce drainage of fluids contained therein in a desired direction, and wherein the reservoirs have a plurality of shelves.

29. The assay plate of claim 28, wherein the desired direction is towards a single plane or a single point.

30. The assay plate of claim 29, wherein the reservoirs each have a spout portion, the spout portion having a vertex directed toward the single plane or the single point.

31. The assay plate of claim 30, wherein the plurality of shelves is located about a central axis of the reservoir.

32. The assay plate of claim 31, wherein the plurality of shelves comprises three shelves, wherein a first shelf is located opposite the spout and the other two shelves are located opposite one another, each spaced between the first shelf and the spout.

33. The assay plate of claim 28, wherein each of the plurality of shelves is located between a bottom of the reservoir and an upper edge of the reservoir.

34. The assay plate of claim 28, wherein at least one of the plurality of shelves is generally parallel to a bottom of the reservoir.

35. The assay plate of claim 28, wherein at least one of the plurality of shelves intersects with a sidewall of the reservoir at an angle.

36. The assay plate of claim 28, where at least one of the plurality of shelves is nonparallel to a bottom of the reservoir.

37. The assay plate of claim 28, wherein the reservoirs have volumes of less than about 500 nanoliters.

38. A system for selective and directional centrifugation comprising:
at least one assay plate;
an adapter; and
a centrifuge wedge having a thin corner, a thick corner, and two opposing intermediate corners spaced between the thin corner and thick corner;
wherein the adapter is configured to securely engage both the assay plate and the centrifuge wedge.

39. The system of claim 38, further comprising at least one funnel dimensioned and configured to be complementary to the at least one assay plate.

40. The system of claim 39, wherein the at least one funnel is reversibly connectable to the at least one assay plate.

41. The system of claim 39, wherein the at least one funnel is a funnel array and the funnel array is positionable in the adapter.

42. The system of claim 38, wherein the at least one assay plate comprises a plurality of reservoirs, wherein each of the reservoirs comprises a spout and a plurality of shelves about a central axis.

43. The system of claim 42, wherein the centrifuge wedge allows for the directional centrifugation of a specific shelf of the plurality of shelves, so that during a centrifugation a substrate on the specific shelf is deposited into the reservoir.

44. The system of claim 43, wherein during the centrifugation substances on the other of the plurality of shelves is not deposited into the reservoir.
